(19) United States
(12) Patent Application Publication
(10) Pub. No.: US 2011/0015068 A1
(43) Pub. Date: Jan. 20, 2011

(54) Herbicidal Compositions Comprising Pyroxasulfone V

(75) Inventors: Bernd Sievernich, Hassloch (DE); Anja Simon, Weinheim (DE); William Karl Moberg, Hassloch (DE); Richard R. Evans, Raleigh, NC (US)

Correspondence Address: BRINKS, HOFER, GILSON & LIONE, P.O. BOX 110285, RESEARCH TRIANGLE PARK, NC, 27709, US

(73) Assignee: BASF SE, Ludwigshafen (DE)

(21) Appl. No.: 12/922,811

(22) PCT Filed: Mar. 16, 2009
(86) PCT No.: PCT/EP2009/053076

§ 371 Date: Sep. 15, 2010

Related U.S. Application Data
(60) Provisional application No. 61/037,144, filed on Mar. 17, 2008.
(60) Provisional application No. 61/118,803, filed on Dec. 1, 2008.

(51) Int. Cl. A01N 43/64; A01N 43/54; A01N 43/56; A01N 43/40; A01P 13/00; A01P 13/02

(52) U.S. Cl. 504/134; 504/136; 504/139; 504/130

(57) ABSTRACT

The present invention relates to herbicidally active compositions, which comprise 3-[5-(difluoromethoxy)-1-methyl-3-(trifluoromethyl)pyrazol-4-ylmethylsulfonyl]-4,5-dihydro-5,5-dimethyl-1,2-oxazole [common name pyroxasulfone] and at least one herbicide B which is an selected from protoporphyrinogen-IX-oxidase inhibitors.

The invention furthermore relates to the use of a composition as defined herein for controlling undesirable vegetation in crops. When using the compositions of the invention for this purpose the herbicide A and the at least one herbicide B can be applied simultaneously or in succession in crops, where undesirable vegetation may occur.

The present invention relates to herbicidally active compositions, which comprise 3-[5-(difluoromethoxy)-1-methyl-3-(trifluoromethyl)pyrazol-4-ylmethylsulfonyl]-4,5-dihydro-5,5-dimethyl-1,2-oxazole [common name pyroxasulfone] and at least one herbicide B.

### BACKGROUND OF THE INVENTION

In crop protection, it is desirable in principle to increase the specificity and the reliability of the action of active compounds. In particular, it is desirable for the crop protection product to control the harmful plants effectively and, at the same time, to be tolerated by the useful plants in question.

Pyroxasulfone has been described in EP-A 1364946 and US 2005/0256004.

Although pyroxasulfone is a highly effective pre-emergence herbicide, its activity at low application rates is not always satisfactory. Moreover, pyroxasulfone is known to have only poor post-emergence activity (Y. Yamaji et al., “Application timing and field performance of KIH-485”, Conference Abstract I-1-ii-12B of 11. IUPAC International Congress of Pesticide Chemistry, 2006 Kobe, Japan). Apart from that, its compatibility with certain dicotyledonous crop plants such as cotton, sunflower, soybean, brassica crops such as canola and oilseed rape and some graminaceous plants such as rice, wheat, rye and barley is not always satisfactory, i.e. in addition to the harmful plants, the crop plants are also damaged to an extent which is not acceptable. Though it is in principle possible to spare crop plants by lowering the application rates, the extent of the control of harmful plants is naturally also reduced.

It is known that combined application of certain different herbicides with specific action might result in an enhanced activity of a herbicide component in comparison with a simple additive action. Such an enhanced activity is also termed a synergism or synergistic activity. As a consequence, it is possible to reduce the application rates of herbicidally active compounds required for controlling the harmful plants.

WO 2005/104848 describes compositions containing a herbicidal 3-sulfonylisoxazoline compound such as pyroxasulfone and a herbicide-antagonistically active amount of a safener. Similar compositions are known from WO 2007/006509.

US 2005/256004, for example, discloses that in a pre-emergence treatment, joint application of certain herbicidal 3-sulfonylisoxazoline compounds, such as pyroxasulfone, with atrazine or cyanazine results in an increased overall herbicide action against certain monocotyledonous and dicotyledonous annual broadleaf weeds (lambsquarter, green foxtail, velvetleaf) in comparison with a simple expected additive action.

WO 2006/097322 discloses a herbicidal composition comprising pyroxasulfone and a second herbicide selected from tembotrione, topramezone and 4-hydroxy-3-[[2-[(2-methoxyethoxy)methyl]-6-(trifluoromethyl-3-pyridinyl]carbonyl]bicyclo[3.2.1]oct-3-ene-2-one.

WO 2006/097509 discloses a herbicidal composition comprising a herbicidal 3-sulfonylisoxazoline compound such as pyroxasulfone and a phenyluracil compound.

Unfortunately, it is usually not possible to predict synergistic activity for combinations of known herbicides, even if the compounds show a close structural similarity to known synergistic combinations.

### SUMMARY OF THE INVENTION

It is an object of the present invention to provide herbicidal compositions, which show enhanced herbicide action in comparison with the herbicide action of pyroxasulfone against undesirable harmful plants, in particular against Alopecurus myosuroides, Avena fatua, Bromus spec., Echinocloa spec. Lolium spec., Phalaris spec., Setaria spec., Digitaria spec., Brachiaria spec., Amaranthus spec., Chenopodium spec., Abutilon theophrasti, Galium aparine, Veronica spec., or Solanum spec. and/or to improve their compatibility with crop plants, in particular improved compatibility with wheat, barley, rye, rice, soybean, sunflower, brassica crops and/or cotton. The composition should also have a good herbicidal activity in post-emergence applications. The compositions should also show an accelerated action on harmful plants, i.e. they should effect damaging of the harmful plants more quickly in comparison with application of the individual herbicides.

We have found that this object is achieved, surprisingly, by herbicidally active compositions comprising
a) pyroxasulfone, i.e. 3-[5-(difluoromethoxy)-1-methyl-3-(trifluoromethyl)pyrazol-4-ylmethylsulfonyl]-4,5-dihydro-5,5-dimethyl-1,2-oxazole (hereinafter also referred to as herbicide A);
   and
b) at least one herbicide B which is an selected from protoporphyrinogen-IX-oxidase inhibitors.

The invention relates in particular to compositions in the form of herbicidally active compositions as defined above.

The invention furthermore relates to the use of a composition as defined herein for controlling undesirable vegetation. When using the compositions of the invention for this purpose the herbicide A and the at least one herbicide B can be applied simultaneously or in succession, where undesirable vegetation may occur.

The invention furthermore relates to the use of a composition as defined herein for controlling undesirable vegetation in crops. When using the compositions of the invention for this purpose the herbicide A and the at least one herbicide B can be applied simultaneously or in succession in crops, where undesirable vegetation may occur.

The invention furthermore relates to the use of a composition as defined herein for controlling undesirable vegetation in crops which, by genetic engineering or by breeding, are resistant or tolerant to one or more herbicides and/or pathogens such as plant pathogenous fungi, and/or to attack by insects; preferably resistant or tolerant to one or more herbicides that act as protoporphyrinogen-IX-oxidase inhibitors.

The invention furthermore relates to a method for controlling undesirable vegetation, which comprises applying a herbicidal composition according to the present invention to the undesirable plants. Application can be done before, during and/or after, preferably during and/or after, the emergence of the undesirable plants. The herbicide A and the at least one herbicide B can be applied simultaneously or in succession.

The invention in particular relates to a method for controlling undesirable vegetation in crops, which comprises applying a herbicidal composition according to the present invention in crops where undesirable vegetation occurs or might occur.

The invention furthermore relates to a method for controlling undesirable vegetation, which comprises allowing a composition according to the present invention to act on plants, their habitat or on seed.

In the uses and methods of the present invention it is immaterial whether the herbicide A and the at least one herbicide B are formulated and applied jointly or separately, and, in the case of separate application, in which order the application takes place. It is only necessary, that the herbicide A and the at least one herbicide B are applied in a time frame, which allows simultaneous action of the active ingredients on the plants.

The invention also relates to an herbicide formulation, which comprises a herbicidally active composition as defined herein and at least one carrier material, including liquid and/or solid carrier materials.

### DETAILED DESCRIPTION OF THE INVENTION

Surprisingly, the compositions according to the invention have better herbicidal activity against harmful plants than would have been expected by the herbicidal activity of the individual compounds. In other words, the joint action of pyroxasulfone and the at least one herbicide B results in an enhanced activity against harmful plants in the sense of a synergy effect (synergism). For this reason, the compositions can, based on the individual components, be used at lower application rates to achieve a herbicidal effect comparable to the individual components. Moreover, the compositions of the present invention provide good post-emergence herbicidal activity, i.e. the compositions are particularly useful for combating/controlling harmful plants after their emergence. Apart form that, the compositions of the present invention show good crop compatibility, i.e. their use in crops leads to a reduced damage of the crop plants and/or does not result in increased damage of the crop plants.

As used herein, the terms “controlling” and “combating” are synonyms.

As used herein, the terms “undesirable vegetation” and “harmful plants” are synonyms.

The compositions of the invention comprise pyroxasulfone as a first component a).

As a second component b), the compositions of the invention comprise at least one herbicide B which is an inhibitor of protoporphyrinogen-IX-oxidase (PPO inhibitor). PPO inhibitors are compounds, which have a mode of action comprising the inhibition of a step of the chlorophyll biosynthesis in plants and which belong to the group E of the HRAC classification system (see HRAC, Classification of Herbicides According to Mode of Action, http://www.plantprotection.org/hrac/MOA.html).

According to the present invention the PPO inhibitor is preferably selected from the group consisting of:
b.1 phenyluracil and pyrazol type herbicides;
b.2 triazolone and oxadiazolone herbicides;
b.3 dicarboximide herbicides;
b.4 nitrophenylether herbicides; and
b.5 triazindione herbicides; and
b.6 dicarboxamide herbicides.

Phenyluracil herbicides (group b.1) include benzfendizone and compounds of the formula I and the salts thereof,

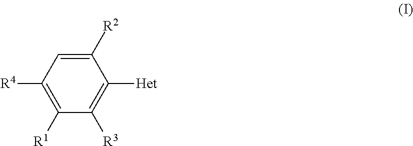

wherein
R¹ is selected from the group consisting of the radicals propargyloxy, allyloxy, isopropyloxy, C(═O)NHSO₂NR^{1a}R^{1b}, C(═O)N—NR^{1a}R^{1b}, O—CR^{1a}R^{1c}—C(═O)—OR^{1e}, C(═O)O—CR^{1a}R^{1c}—C(═O)—OR^{1e}, C(═O)O—R^{1b}, C(═O)O—CHR^{1c}—C(═O)NHSO₂NR^{1a}R^{1b}, NHSO₂NR^{1a}R^{1b}, SO₂NHC(═O)NR^{1a}R^{1b}, CH₂—CH(Cl)CO₂—R^{1d} and the radical of the formula OC(CH₃)₂—C(═O)—OR^{1e}; where
   R^{1a} is hydrogen or C₁-C₄-alkyl;
   R^{1b} is C₁-C₄-alkyl;
   R^{1c} is hydrogen or C₁-C₄-alkyl;
   R^{1d} is hydrogen or C₁-C₄-alkyl or a agriculturally acceptable cation; and
   R^{1e} is C₁-C₄-alkyl, propargyl or allyl;
R² is hydrogen, fluorine or chlorine;
R³ is hydrogen or together with R¹ forms a moiety —O—C(R^{3a})═N— or —N═C(R^{3b})—NH—, where
   R^{3a} and R^{3b} are selected, independently of each other, from hydrogen, C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₁-C₆-alkoxy, C₃-C₆-cycloalkyl and C₁-C₂-alkyl substituted by a C₃-C₆-cycloalkyl radical; with R^{1a} and R^{3b} preferably being selected, independently of each other, from C₁-C₄-alkyl, C₁-C₂-haloalkyl, and C₁-C₂-alkyl substituted by a C₃-C₆-cycloalkyl radical with R^{3a} and R^{3b} more preferably being selected, independently of each other, from methyl, ethyl, n-propyl, isopropyl, n-butyl, 2-methylpropyl, trifluoromethyl and cyclopropylmethyl;
R⁴ is halogen or cyano, in particular chlorine or fluorine;
   and
Het is a heterocyclic radical of the formula A:

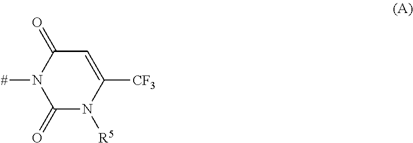

where # indicates the point of attachment and wherein
R⁵ is selected from hydrogen amino, methyl or propargyl and wherein R⁵ is preferably methyl.

Pyrazole type herbicides (group b.1) include compounds of the formula I′ and the salts thereof,

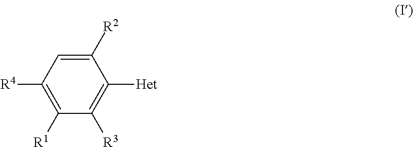

wherein R¹, R², R³ and R⁴ are as defined for formula I and wherein Het is a radical of the formula B

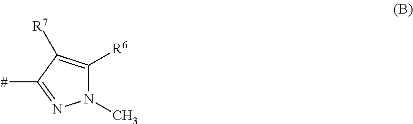

where # indicates the point of attachment and wherein
R⁶ is selected from difluoromethoxy, trifluoromethyl and methylsulfonyl;
R⁷ is selected from halogen or methyl, in particular from chlorine or bromine.

The organic moieties mentioned in the above definitions of the variables are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine, in particular fluorine, chlorine or bromine.

The term “alkyl” as used herein denotes in each case a straight-chain or branched alkyl group having usually from 1 to 6 carbon atoms, preferably from 1 to 4 carbon atoms, more preferably from 1 to 3 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

The term “haloalkyl” as used herein denotes in each case a straight-chain or branched alkyl group having usually from 1 to 6 carbon atoms, preferably from 1 to 4 carbon atoms, wherein the hydrogen atoms of this group are partially or totally replaced with halogen atoms. Preferred haloalkyl moieties are selected from C₁-C₄-haloalkyl, more preferably from C₁-C₂-haloalkyl, in particular from C₁-C₂-fluoroalkyl such as fluoromethyl, difluoromethyl, trifluoromethyl, 1-fluoroethyl, 2-fluoroethyl, 2,2-difluoroethyl, 2,2,2-trifluoroethyl, pentafluoroethyl and the like.

The term “alkoxy” as used herein denotes in each case a straight-chain or branched alkyl group which is bound via an oxygen atom at any position in the alkyl group and has usually from 1 to 6 carbon atoms, preferably 1 to 4 carbon atoms. Examples of an alkoxy group are methoxy, ethoxy, n-propoxy, iso-propoxy, n-butyloxy, 2-butyloxy, iso-butyloxy, tert-butyloxy and the like.

The term “haloalkoxy” as used herein denotes in each case a straight-chain or branched alkoxy group having from 1 to 6 carbon atoms, preferably 1 to 4 carbon atoms, wherein the hydrogen atoms of this group are partially or totally replaced with halogen atoms, in particular fluorine atoms. Preferred haloalkoxy moieties include C₁-C₄-haloalkoxy, in particular C₁-C₂-fluoroalkoxy, such as fluoromethoxy, difluoro-methoxy, trifluoromethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoro-ethoxy, 2,2-dichloro-2-fluorethoxy, 2,2,2-trichloroethoxy, pentafluoroethoxy and the like.

The term “cycloalkyl” as used herein and in the cycloalkyl moieties of cycloalkyl-alkyl denotes in each case a monocyclic saturated carbocyclic radical having usually from 3 to 6 carbon atoms, such as cyclopropyl, cyclobutyl, cyclopentyl and cyclohexyl.

The term “alkenyl” as used herein denotes in each case a singly unsaturated hydrocarbon radical having usually 3 to 6, or preferably 3 to 4 carbon atoms, such as vinyl, allyl (2-propen-1-yl), 1-propen-1-yl, 2-propen-2-yl, methallyl (2-methylprop-2-en-1-yl), 2-buten-1-yl, 3-buten-1-yl, 2-penten-1-yl, 3-penten-1-yl, 4-penten-1-yl, 1-methylbut-2-en-1-yl, 2-ethylprop-2-en-1-yl and the like.

The term “haloalkenyl” as used herein denotes in each case a straight-chain or branched alkenyl group, as defined above, having usually from 3 to 6 carbon atoms, preferably from 3 to 4 carbon atoms, wherein the hydrogen atoms of this group are partially or totally replaced with halogen atoms.

The term “alkynyl” as used herein denotes in each case a singly unsaturated hydrocarbon radical having usually from 3 to 6 carbon atoms, such as ethynyl, propargyl (2-propyn-1-yl), 1-propyn-1-yl, 1-methylprop-2-yn-1-yl), 2-butyn-1-yl, 3-butyn-1-yl, 1-pentyn-1-yl, 3-pentyn-1-yl, 4-pentyn-1-yl, 1-methylbut-2-yn-1-yl, 1-ethylprop-2-yn-1-yl and the like.

The term “haloalkynyl” as used herein denotes in each case a straight-chain or branched alkynyl group, as defined above, having usually from 3 to 6 carbon atoms, preferably from 3 to 4 carbon atoms, wherein the hydrogen atoms of this group are partially or totally replaced with halogen atoms.

The term “alkyl substituted by an alkoxy radical” as used herein refers to linear or branched alkyl having usually 1 to 4 carbon atoms, wherein 1 of those carbon atoms carries an alkoxy radical usually having 1 to 4 carbon atoms. Examples are CH₂OCH₃, CH₂—OC₂H₅, n-propoxymethyl, CH₂—OCH(CH₃)₂, n-butoxymethyl, (1-methylpropoxy)-methyl, (2-methylpropoxy)methyl, CH₂—OC(CH₃)₃, 2-(methoxy)ethyl, 2-(ethoxy)ethyl, 2-(n-propoxy)-ethyl, 2-(1-methylethoxy)-ethyl, 2-(n-butoxy)ethyl, 2-(1-methylpropoxy)-ethyl, 2-(2-methylpropoxy)-ethyl, 2-(1,1-dimethylethoxy)-ethyl, 2-(methoxy)-propyl, 2-(ethoxy)-propyl, 2-(n-propoxy)-propyl, 2-(1-methylethoxy)-propyl, 2-(n-butoxy)-propyl, 2-(1-methylpropoxy)-propyl, 2-(2-methylpropoxy)-propyl, 2-(1,1-dimethylethoxy)-propyl, 3-(methoxy)-propyl, 3-(ethoxy)-propyl, 3-(n-propoxy)-propyl, 3-(1-methylethoxy)-propyl, 3-(n-butoxy)-propyl, 3-(1-methylpropoxy)-propyl, 3-(2-methylpropoxy)-propyl, 3-(1,1-dimethylethoxy)-propyl, 2-(methoxy)-butyl, 2-(ethoxy)-butyl, 2-(n-propoxy)-butyl, 2-(1-methylethoxy)-butyl, 2-(n-butoxy)-butyl, 2-(1-methylpropoxy)-butyl, 2-(2-methyl-propoxy)-butyl, 2-(1,1-dimethylethoxy)-butyl, 3-(methoxy)-butyl, 3-(ethoxy)-butyl, 3-(n-propoxy)-butyl, 3-(1-methylethoxy)-butyl, 3-(n-butoxy)-butyl, 3-(1-methylpropoxy)-butyl, 3-(2-methylpropoxy)-butyl, 3-(1,1-dimethylethoxy)-butyl, 4-(methoxy)-butyl, 4-(ethoxy)-butyl, 4-(n-propoxy)-butyl, 4-(1-methylethoxy)-butyl, 4-(n-butoxy)-butyl, 4-(1-methylpropoxy)-butyl, 4-(2-methylpropoxy)-butyl, 4-(1,1-dimethylethoxy)-butyl and the like.

The term “alkyl substituted by cycloalkyl radical” as used herein refers to linear or branched alkyl having usually 1 to 2 carbon atoms, wherein 1 of those carbon atoms carries a cycloalkyl radical usually having 3 to 6 carbon atoms. Examples are CH₂-cylcopropyl (=cyclopropylmethyl), CH₂-cylcobutyl (=cyclobutylmethyl), CH₂-cylcopentyl (=cyclopentylmethyl), CH₂-cylcohexyl (=cyclohexylmethyl), CH₂CH₂-cylcopropyl (=2-cyclopropylethyl), CH₂CH₂-cylcobutyl (=2-cyclobutylethyl), CH₂CH₂-cylcopentyl (=2-cyclopentylethyl), CH₂CH₂-cylcohexyl (=2-cyclohexylethyl), CH(CH₃)-cylcopropyl (=1-cyclopropylethyl), CH(CH₃)-cylcobutyl (=1-cyclobutylethyl), CH(CH₃)-cylcopentyl (=1-cyclopentylethyl) or CH(CH₃)-cylcohexyl (=1-cyclohexylethyl).

According to a preferred embodiment of the invention, the phenyluracil herbicides (group b.1) are selected from benzfendizone and compounds of the formula Ia and the salts thereof,

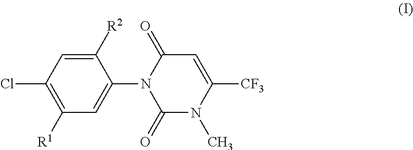

wherein
R¹ is selected from the group consisting of the radicals propargyloxy, allyloxy, iso-propyloxy, C(═O)NHSO₂NR^{1a}R^{1b}, C(═O)N—NR^{1a}R^{1b}, C(═O)O—CR^{1a}R^{1c}—C(═O)—OR^{1e}, C(═O)O—R^{1b}, C(═O)O—CHR^{1c}—C(═O)NHSO₂NR^{1a}R^{1b}, NHSO₂NR^{1a}R^{1b}, SO₂NHC(═O)NR^{1a}R^{1b}, CH₂—CH(Cl)CO₂—R^{1d} and the radical of the formula OC(CH₃)₂—C(═O)—OR^{1e}; where
   R^{1a} is hydrogen or C₁-C₄-alkyl;
   R^{1b} is C₁-C₄-alkyl;
   R^{1c} is hydrogen or C₁-C₄-alkyl;
   R^{1d} is hydrogen or C₁-C₄-alkyl or a agriculturally acceptable cation; and
   R^{1e} is C₁-C₄-alkyl, propargyl or allyl; and
R² is hydrogen, fluorine or chlorine.

Examples of particularly preferred compounds of formula Ia include
butafenacil (R¹=C(═O)O—C(CH₃)₂—C(═O)—OCH₂CH═CH₂, R²═H),
flupropacil (R¹=C(═O)O—CH(CH₃)₂, R²═H), and
saflufenacil (R¹=C(═O)NHSO₂N(CH₃)(CH(CH₃)₂), R²═F),
   with a particular preference given to saflufenacil.

According to another preferred embodiment of the invention the phenyluracil herbicides (group b.1) are selected from compounds of the formula Ib and the salts thereof,

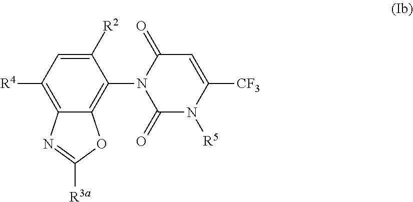

wherein R², R^{3a}, R⁴ and R⁵ are as defined herein, and wherein R², R^{3a}, R⁴ and R⁵, independently of each other, and more preferably in combination have one of the following meanings
R² is preferably fluorine or chlorine,
R⁴ is preferably chlorine,
R⁵ is preferably methyl and
R^{3a} is preferably selected from C₁-C₄-alkyl, C₁-C₂-haloalkyl, and C₁-C₂-alkyl substituted by a C₃-C₆-cycloalkyl radical with R^{3a} being more preferably selected from methyl, ethyl, n-propyl, isopropyl, n-butyl, 2-methylpropyl, trifluoromethyl and cyclopropylmethyl.

Examples of particularly preferred compounds of formula Ib are selected from the group of compounds of the formula Ib, wherein
R² is fluorine, R⁴ is chlorine, R⁵ is methyl and R^{3a} is cyclopropylmethyl,
R² is chlorine, R⁴ is chlorine, R⁵ is methyl and R^{3a} is cyclopropylmethyl,
R² is fluorine, R⁴ is chlorine, R⁵ is methyl and R^{3a} is methyl,
R² is chlorine, R⁴ is chlorine, R⁵ is methyl and R^{3a} is methyl,
R² is fluorine, R⁴ is chlorine, R⁵ is methyl and R^{3a} is ethyl,
R² is chlorine, R⁴ is chlorine, R⁵ is methyl and R^{3a} is ethyl,
R² is fluorine, R⁴ is chlorine, R⁵ is methyl and R^{3a} is trifluoromethyl or
R² is chlorine, R⁴ is chlorine, R⁵ is methyl and R^{3a} is trifluoromethyl.

An especially preferred compound of this embodiment is a compound of the formula Ib, wherein R² is fluorine, R⁴ is chlorine, R⁵ is methyl and R^{3a} is cyclopropylmethyl.

According to another preferred embodiment of the invention the phenyluracil herbicides (group b.1) are selected from compounds of the formula Id and the salts thereof,

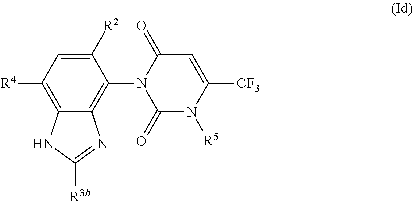

wherein R², R^{3b}, R⁴ and R⁵ are as defined herein, and wherein R², R^{3a}, R⁴ and R⁵, independently of each other, and more preferably in combination have one of the following meanings
R² is preferably fluorine or chlorine,
R⁴ is preferably chlorine,
R⁵ is preferably methyl and
R^{3b} is preferably selected from C₁-C₄-alkyl, C₁-C₂-haloalkyl, and C₁-C₂-alkyl substituted by a C₃-C₆-cycloalkyl radical with R^{3b} being more preferably selected from methyl, ethyl, n-propyl, isopropyl, n-butyl, 2-methylpropyl, trifluoromethyl and cyclopropylmethyl.

Examples of particularly preferred compounds of formula Id are selected from the group of compounds of the formula Id, wherein
R² is fluorine, R⁴ is chlorine, R⁵ is methyl and R^{3b} is cyclopropylmethyl,
R² is chlorine, R⁴ is chlorine, R⁵ is methyl and R^{3b} is cyclopropylmethyl,
R² is fluorine, R⁴ is chlorine, R⁵ is methyl and R^{3b} is methyl,
R² is chlorine, R⁴ is chlorine, R⁵ is methyl and R^{3b} is methyl,
R² is fluorine, R⁴ is chlorine, R⁵ is methyl and R^{3b} is ethyl,
R² is chlorine, R⁴ is chlorine, R⁵ is methyl and R^{3b} is ethyl,
R² is fluorine, R⁴ is chlorine, R⁵ is methyl and R^{3b} is trifluoromethyl or
R² is chlorine, R⁴ is chlorine, R⁵ is methyl and R^{3b} is trifluoromethyl.

An especially preferred compound is a compound of the formula Id, wherein R² is fluo-rine, R⁴ is chlorine, R⁵ is methyl and R^{3b} is trifluoromethyl.

Phenyluracil herbicides and pyrazole type herbicides (group b.1) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

According to another preferred embodiment of the invention the pyrazole type herbicides (group b.1) are selected from compounds of the formula Ic and the salts thereof,

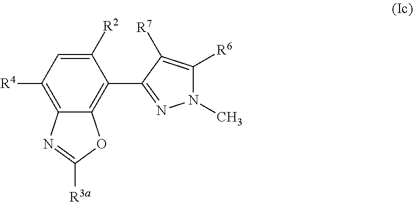

wherein R², R^{3a}, R⁴, R⁶ and R⁷ are as defined herein, and wherein R², R^{3a}, R⁴, R⁶ and R⁷, independently of each other, and more preferably in combination have one of the following meanings
R² is preferably fluorine or chlorine,
R⁴ is preferably chlorine,
R⁶ is preferably difluoromethoxy,
R⁷ is preferably chlorine or bromine and
R^{3b} is preferably selected from C₁-C₄-alkyl, C₁-C₂-haloalkyl, and C₁-C₂-alkyl substituted by a C₃-C₆-cycloalkyl radical with R^{3b} being more preferably selected from methyl, ethyl, n-propyl, isopropyl, n-butyl, 2-methylpropyl, trifluoromethyl and cyclopropylmethyl.

Examples of particularly preferred compounds of formula Ic are selected from the group of compounds of the formula Ic, wherein
R² is fluorine, R⁴ is chlorine, R⁶ is difluoromethoxy, R⁷ is chlorine and R^{3a} is ethyl,
R² is chlorine, R⁴ is chlorine, R⁶ is difluoromethoxy, R⁷ is chlorine and R^{3a} is ethyl,
R² is fluorine, R⁴ is chlorine, R⁶ is difluoromethoxy, R⁷ is bromine and R^{3a} is ethyl, or
R² is chlorine, R⁴ is chlorine, R⁶ is difluoromethoxy, R⁷ is bromine and R^{3a} is ethyl.

According to a further preferred embodiment of the invention, the pyrazole type herbicides (group b.1) are selected from compounds of the formula Ie and the salts thereof,

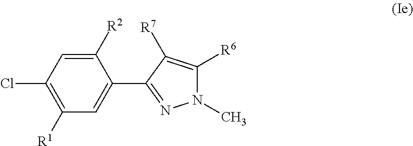

wherein
R¹ is selected from the group consisting of the radicals propargyloxy, allyloxy, isopropyloxy, C(═O)NHSO₂NR^{1a}R^{1b}, C(═O)N—NR^{1a}R^{1b}, O—CR^{1a}R^{1c}—C(═O)—OR^{1e}, C(═O)O—CR^{1a}R^{1c}—C(═O)—OR¹e, C(═O)O—R^{1b}, C(═O)O—CHR^{1c}—C(═O)NHSO₂NR^{1a}R^{1b}, NHSO₂NR^{1a}R^{1b}, SO₂NHC(═O)NR^{1a}R^{1b}, CH₂—CH(Cl)CO₂—R^{1d} and the radical of the formula OC(CH₃)₂—C(═O)—OR^{1e}; where
   R^{1a} is hydrogen or C₁-C₄-alkyl;
   R^{1b} is C₁-C₄-alkyl;
   R^{1c} is hydrogen or C₁-C₄-alkyl;
   R^{1d} is hydrogen or C₁-C₄-alkyl or a agriculturally acceptable cation; and
   R^{1e} is C₁-C₄-alkyl, propargyl or allyl;
R² is hydrogen, fluorine or chlorine;
R⁶ is selected from difluoromethoxy, trifluoromethyl and methylsulfonyl; and
R⁷ is selected from halogen or methyl, in particular from chlorine or bromine.

Examples of particularly preferred compounds of formula Ie include
fluazolate (R¹=C(═O)O—CH(CH₃)₂, R²=F, R⁶=trifluoromethyl, R⁷=bromine), and
pyraflufen-ethyl (R¹=O—CH₂—C(═O)O—CH₂CH₃, R²=F, R⁶=difluoromethoxy, R⁷=chlorine).

Triazolone and oxadiazolone herbicides (b.2) include in particular compounds of the formula II and their salts,

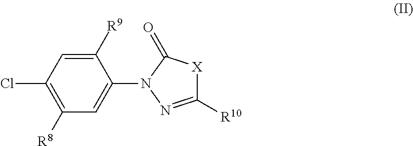

wherein
X is O or NR¹¹,
R⁸ is selected from the group consisting of propargyloxy, allyloxy, isopropyloxy, the radical of the formula CH₂—CH(CI)CO₂—R¹² and the radical of the formula NH—SO₂—CH₃;
R⁹ is fluorine or chlorine;
R¹⁰ is CH₃, tert.-butyl;
R¹¹ is CHF2, or together with R¹⁰ may for 1,4-butandiyl;
R¹² is hydrogen, C₁-C₆-alkyl or a agriculturally acceptable cation.

Examples of the compounds of formula I include azafenidin, carfentrazone, sulfentrazone, oxadiazon and oxadiargyl. Also included are the salts of carfentrazone, in particular its sodium salt, potassium salt, ammonium salt or substituted ammonium salts as defined above, in particular mono-, di and tri-C₁-C₈-alkylammonium salts such as isopropylammonium salts and the esters of carfentrazone, in particular its C₁-C₈-alkyl esters, such as methylesters, ethylesters, isopropyl esters. A suitable example of such an ester is carfentrazone-ethyl.

Triazolone and oxadiazolone herbicides (group b.2) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Dicarboximide herbicides (b.3) include compounds of the formula III,

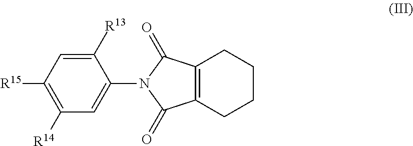

wherein
R¹³ is hydrogen, fluorine or chlorine;
R¹⁴ is selected from the group consisting of propargyloxy, allyloxy, 1-methyl-2-propinyloxy, O—CH₂CO₂—R¹⁶, CH═C(Cl)CO₂—R¹⁶ and isopropyloxy;
R¹⁵ is fluorine or chlorine; or
R¹⁴ and R¹⁵ together form a moiety O—CH₂—C(═O)—NR¹⁷, where R¹⁷ is a propargyl radical and where the oxygen atom is meta with regard to the position of R¹³;
R¹⁶ is hydrogen, C₁-C₆-alkyl or an agriculturally acceptable cation.

Examples of compounds of formula III include cinidon, flumioxazin, flumiclorac, and flumipropyn. Also included are the salts of cinidon and flumiclorac, in particular their sodium salts, potassium salts, ammonium salts or substituted ammonium salts as defined above, in particular mono-, di and tri-C₁-C₈-alkylammonium salts such as isopropylammonium salts, and the esters of cinidon and flumiclorac, in particular their C₁-C₈-alkyl esters, such as methylesters, ethylesters, isopropyl esters. Suitable examples of such esters are cinidon-ethyl and flumiclorac-pentyl.

Dicarboximide herbicides (group b.3) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Nitrophenylether herbicides (b.4) include furyloxyphen and compounds of the formula IV,

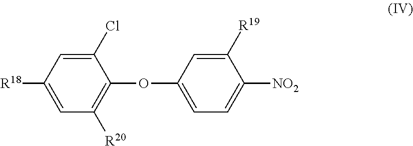

wherein
R¹⁸ is chlorine or trifluoromethyl;
R¹⁹ is selected from the group consisting of hydrogen, C₁-C₄-alkoxy, CO₂—R²¹, C(═O)O—CH₂CO₂—R²¹,C(═O)O—CH(CH₃)CO₂—R²¹, C(═O)NH—SO₂—R²²;
R²⁰ is hydrogen, fluorine or chlorine;
R²¹ is hydrogen, C₁-C₆-alkyl or a agriculturally acceptable cation; and
R²² is C₁-C₄-alkyl.

Examples of compounds of formula IV include nitrofen, bifenox, oxyfluorfen, acifluorfen, fluoroglycofen, fluorodifen, fomesafen, lactofen, halosafen, chlornitrofen, fluornitrofen, chlomethoxyfen and nitrofluorfen and their salts and esters. In particular included are the salts of acifluorfen and fluoroglycofen, in particular the sodium salts, potassium salts, ammonium salts or substituted ammonium salts as defined above, in particular mono-, di and tri-C₁-C₈-alkylammonium salts such as isopropylammonium salts and the esters of acifluorfen and fluoroglycofen, in particular their C₁-C₈-alkyl esters, such as methylesters, ethylesters, isopropyl esters. A suitable example of such a salt is acifluorfen-sodium. Suitable examples of such esters are acifluorfen-methyl and fluoro-glycofen-ethyl.

Nitrophenylether herbicides (group d.) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Triazinedione type herbicides (group b.5) include e.g. compounds of the formula V and the salts thereof,

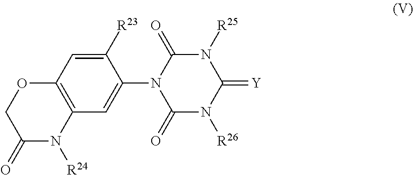

wherein
R²³ is hydrogen, fluorine or chlorine;
R²⁴ is selected from hydrogen, C₁-C₆-alkyl, C₁-C₆-haloalkyl, C₃-C₆-alkenyl, C₃-C₆-haloalkenyl, C₃-C₆-alkynyl, C₃-C₆-haloalkynyl, C₁-C₆-alkoxy, C₃-C₆-cycloalkyl and C₁-C₂-alkyl substituted by a C₃-C₆-cycloalkyl radical;
R²⁵ is selected from hydrogen, amino, methyl and propargyl;
R²⁶ is selected from hydrogen and methyl;
and Y is O or S.

Preference is given to compounds of the formula V, wherein Y, R²³, R²⁴, R²⁵ and R²⁶, independently of each other, and more preferably in combination have one of the following meanings:

### Y is S,

R²³ is preferably fluorine or chlorine,
R²⁴ is preferably C₃-C₆-alkyl, C₃-C₆-alkenyl, or C₃-C₆-alkynyl, in particular C₃-C₆-alkynyl, and especially propargyl,
R²⁵ is preferably methyl, and
R²⁶ is preferably methyl.

In a particular preferred compound of the formula V the variable Y is S, R²³ is fluorine, R²⁴ is propargyl, R²⁵ is methyl and R²⁶ is methyl.

Dicarboxamide type herbicides (group b.6) include e.g. compounds of the formula VI and the salts thereof,

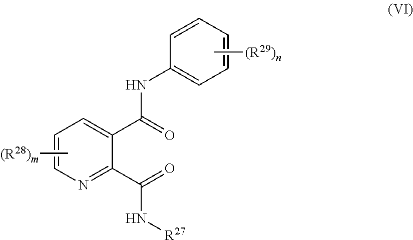

wherein
m is 0, 1, 2, or 3, in particular 1 or 2;
n is 0, 1, 2, 3 or 4, in particular 1 or 2;
R²⁷ is selected from C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₃-C₆-cycloalkyl, C₁-C₄-alkyl substituted by a C₁-C₄-alkoxy radical, and C₁-C₂-alkyl substituted by a C₃-C₆-cycloalkyl radical;
R²⁸ is selected from halogen, C₁-C₃-alkyl, C₁-C₃-haloalkyl, C₁-C₃-alkoxy, and C₁-C₃-alkyl substituted by a C₁-C₃-alkoxy radical, it being possible for m=2 or 3 that the radicals R²⁸ are identical or different from each other,
R²⁹ is selected from halogen, cyano, nitro, C₁-C₄-alkyl, C₁-C₄-haloalkyl, C₁-C₄-alkylsulfonyl, C₁-C₄-alkoxy, C₁-C₄-alkyl substituted by a C₁-C₄-alkoxy radical, C₁-C₂-alkyl substituted by a C₃-C₆-cycloalkyl radical and a radical CO₂R³⁰, it being possible for n=2, 3 or 4 that the radicals R²⁹ are identical or different from each other;
R³⁰ is selected from C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₃-C₆-cycloalkyl, C₁-C₄-alkyl substituted by a C₁-C₄-alkoxy radical and C₁-C₂-alkyl substituted by a C₃-C₆-cycloalkyl radical.

Preference is given to compounds of the formula VI, wherein m, n, R²⁷, R²⁷, R²⁹ and R³⁰, independently of each other, and more preferably in combination have one of the following meanings:
m is 1;
n is 1, 2 or 3;
R²⁷ is selected from C₁-C₆-alkyl, C₃-C₆-cycloalkyl, and C₁-C₂-alkyl substituted by a C₃-C₆-cycloalkyl radical, in particular cyclopropylmethyl;
R²⁸ is selected from halogen and C₁-C₃-alkyl, in particular methyl;
R²⁹ is selected from halogen, C₁-C₄-alkyl and a radical CO₂R³⁰, it being possible for n=2 or 3 that the radicals R²⁹ are identical or different from each other;
R³⁰ is C₁-C₆-alkyl.

A particular preferred compound of the formula VI is the compound of the following formula VIa:

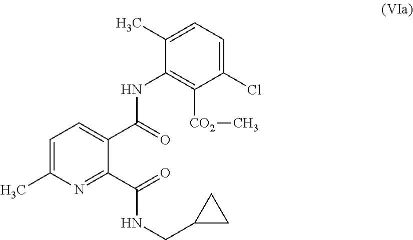

In the compositions of the present invention the relative weight ratio of pyroxasulfone to herbicide B is preferably in the range from 1:500 to 500:1, in particular in the range from 1:250 to 250:1 and more preferably from 100:1 to 1:100. Accordingly, in the methods and uses of the invention, pyroxasulfone and the at least one herbicide B are applied within these weight ratios.

The compositions of the invention may also comprise, as a component c), one or more safeners. Safeners, also termed as herbicide safeners, are organic compounds which in some cases lead to better crop plant compatibility when applied jointly with specifically acting herbicides. Some safeners are themselves herbicidally active. In these cases, the safeners act as antidote or antagonist in the crop plants and thus reduce or even prevent damage to the crop plants. However, in the compositions of the present invention, safeners are generally not required. Therefore, a preferred embodiment of the invention relates to compositions which contain no safener or virtually no safener (i.e. less than 1% by weight, based on the total amount of herbicide A and herbicide B).

Suitable safeners, which can be used in the compositions according to the present invention, are known in the art, e.g. from
The Compendium of Pesticide Common Names (http://www.alanwood.net/pesticides/); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7th Edition, Weed Science Society of America, 1994; and
K. K. Hatzios, Herbicide Handbook, Supplement to 7th Edition, Weed Science Society of America, 1998.

Safeners include e.g. benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloracetyl)-1,3-oxazolidine, 4-(dichloroacetyl)-1-oxa-4-azaspiro[4.5]decane and oxabetrinil, as well as thereof agriculturally acceptable salts and, provided they have a carboxyl group, their agriculturally acceptable derivatives. 2,2,5-Trimethyl-3-(dichloroacetyl)-1,3-oxazolidine [CAS No. 52836-31-4] is also known under the name R-29148. 4-(Dichloroacetyl)-1-oxa-4-azaspiro[4.5]decane [CAS No. 71526-07-03] is also known under the names AD-67 and MON 4660.

As a safener, the compositions according to the invention particularly preferably comprise at least one of the compounds selected from the group of benoxacor, cloquintocet, cyprosulfamide, dichlormid, fenchlorazole, fenclorim, fluxofenim, furilazole, isoxadifen, mefenpyr, naphthalic anhydride, 2,2,5-trimethyl-3-(dichloroacetyl)-1,3-oxazolidine, and 4-(dichloroacetyl)-1-oxa-4-azaspiro[4.5]decane and oxabetrinil; and the agriculturally acceptable salt thereof and, in the case of compounds having a COOH group, an agriculturally acceptable derivative as defined below.

A preferred embodiment of the invention relates to compositions which contain no safener or virtually no safener (i.e. less than 1% by weight, based on the total amount of herbicide A and the at least one herbicide B is applied).

The compositions of the invention may also comprise, as a component d), one or more herbicides D) which are different from the herbicides A and B. Such further herbicides D may broaden the activity spectrum of the inventive compositions. However, further herbicides D are generally not required. Therefore, a preferred embodiment of the invention relates to compositions which contain no further herbicide D or virtually no further herbicide D (i.e. less than 1% by weight, based on the total amount of herbicide A and herbicide B).

In particular, the compositions of the present invention consist of the herbicide A and the at least one herbicide B, i.e. they neither contain a safener nor a further herbicide D.

If the compounds of herbicide compounds mentioned as herbicides B, herbicides D and safeners (see below) have functional groups, which can be ionized, they can also be used in the form of their agriculturally acceptable salts. In general, the salts of those cations are suitable whose cations have no adverse effect on the action of the active compounds (“agricultural acceptable”).

In general, the salts of those cations are suitable whose cations have no adverse effect on the action of the active compounds (“agricultural acceptable”). Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium (hereinafter also termed as organoammonium) in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium (olamine salts), 2-(2-hydroxyethoxy)eth-1-ylammonium (diglycolamine salts), di(2-hydroxyeth-1-yl)ammonium (diolamine salts), tris(2-hydroxyeth-1-yl)ammonium (trolamine salts), tris(3-propanolammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

In the compositions according to the invention, the compounds that carry a carboxyl group can also be employed in the form of agriculturally acceptable derivatives, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester. Preferred derivatives are the esters.

The compositions of the present invention are suitable for controlling a large number of harmful plants, including monocotyledonous weeds, in particular annual weeds such as gramineous weeds (grasses) including Echinochloa species such as barnyardgrass (Echinochloa crusgalli var. crus-galli), Digitaria species such as crabgrass (Digitaria sanguinalis), Setaria species such as green foxtail (Setaria viridis) and giant foxtail (Setaria faberii), Sorghum species such as johnsongrass (Sorghum halepense Pers.), Avena species such as wild oats (Avena fatua), Cenchrus species such as Cenchrus echinatus, Bromus species, Lolium species, Phalaris species, Eriochloa species, Panicum species, Brachiaria species, annual bluegrass (Poa annua), blackgrass (Alopecurus myosuroides), Aegilops cylindrica, Agropyron repens, Apera spica-venti, Eleusine indica, Cynodon dactylon and the like.

The compositions of the present invention are also suitable for controlling a large number of dicotyledonous weeds, in particular broad leaf weeds including Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Acanthospermum species, Anthemis species, Atriplex species, Cirsium species, Convolvulus species, Conyza species, Cassia species, Commelina species, Datura species, Euphorbia species, Geranium species, Galinsoga species, morningglory (Ipomoea species), Lamium species, Malva species, Matricaria species, Sysimbrium species, Solanum species, Xanthium species, Veronica species, Viola species, common chickweed (Stellaria media), velvetleaf (Abutilon theophrasti), Hemp sesbania (Sesbania exaltata Cory), Anoda cristata, Bidens pilosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia brasiliensis, and the like.

The compositions of the present invention are also suitable for controlling a large number of annual and perennial sedge weeds including Cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iris L.), and the like.

The compositions according to the present invention are suitable for combating/controlling common harmful plants in useful plants (i.e. in crops). The compositions of the present invention are generally suitable for combating/controlling undesired vegetation in
Grain crops, including e.g.
   cereals (small grain cereals) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare);
   maize (corn; Zea mays);
   sorghum (e.g. Sorghum bicolour);
   rice (Oryza spp. such as Oryza sativa and Oryza glaberrima); and
   sugar cane;
Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (lens culinaris var.);
brassicaceae, including e.g. canola (Brassica napus), oilseed rape (Brassica napus), cabbage (B. oleracea var.), mustard such as B. juncea, B. campestris, B. narinosa, B. nigra and B. tourneforti\dot{r}, and turnip (Brassica rapa var.);
other broadleaf crops including e.g. sunflower, cotton, flax, linseed, sugarbeet, potato and tomato;
TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;
turf, pasture and rangeland;
onion and garlic;
bulb ornamentals such as tulips and narcissus;
conifers and deciduous trees such as pinus, fir, oak, maple, dogwood, hawthorne, crabapple, and rhamnus (buckthorn); and
garden ornamentals such as petunia, marigold, roses and snapdragon.

The compositions of the present invention are in particular suitable for combating/controlling undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, pomefruit, such as apple and pear, stonefruit, such as peach, almond, walnut, olive, cherry, plum and apricot, citrus, coffee, pistachio, garden ornamentals, such as roses, petunia, marigold, snap dragon, bulb ornamentals such as tulips and narcissus, onion, garlic, conifers and deciduous trees such as pinus, fir, oak, maple, dogwood, hawthorne, crabapple and rhamnus.

The compositions of the present invention are most suitable for combating/controlling undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus, pistachio, onion, garlic and deciduous trees.

The compositions of the invention are particularly suitable for application in wheat, barley, rye, rice, corn, sugarcane, sorghum, soybean, pulse crops, sunflower, potato, cotton, turf, grapes, stonefruit, citrus and pistachio.

If not stated otherwise, the compositions of the invention are suitable for application in any variety of the aforementioned crop plants.

The compositions according to the invention can also be used in crop plants which are resistant or tolerant to one or more herbicides owing to genetic engineering or breeding, which are resistant or tolerant to one or more pathogens such as plant pathogenous fungi owing to genetic engineering or breeding, or which are resistant or tolerant to attack by insects owing to genetic engineering or breeding. Suitable are for example crop plants, preferably corn, wheat, sunflower, sugarcane, cotton, rice, canola, oilseed rape or soybeans, which crops are resistant or tolerant to herbicidal PPO inhibitors, such as, for example, butafenacil, saflufenacil, azafenidin, carfentrazone, sulfentrazone, oxadiazon, oxadiargyl, cinidon, flumioxazin, flumiclorac, flumipropyn, acifluorfen, bifenox, chlomethoxyfen, chlornitrofen, fluoronitrofen, fomesafen, halosafen, lactofen, nitrofen, nitrofluorfen, or oxyfluorfen, or crop plants which, owing to introduction of the gene for Bt toxin by genetic modification, are resistant to attack by certain insects.

The compositions of the present invention can be applied in conventional manner by using techniques a skilled person is familiar with. Suitable techniques include spraying, atomizing, dusting, spreading or watering. The type of application depends on the intended purpose in a well known manner; in any case, the techniques should ensure the finest possible distribution of the active ingredients according to the invention.

The compositions can be applied pre- or post-emergence, i.e. before, during and/or after emergence of the undesirable plants. When the compositions are used in crops, they can be applied after seeding and before the emergence of the crop plants. The compositions invention can, however, also be applied prior to seeding of the crop plants.

It is a particular benefit of the compositions according to the invention that they have a very good post-emergence herbicide activity, i.e. they show a good herbicidal activity against emerged undesirable plants. Thus, in a preferred embodiment of invention, the compositions are applied post-emergence, i.e. during and/or after, the emergence of the undesirable plants. It is particularly advantageous to apply the mixtures according to the invention post-emergent when the undesirable plant starts with leaf development up to flowering. Since the composition show good crop tolerance, even when the crop has already emerged, they can be applied after seeding of the crop plants and in particular during or after the emergence of the crop plants. The compositions can also be applied in a situation, where no crop is present yet at the time of application, e.g. prior to planting of the crop.

In any case herbicide A and the at least one herbicide B and the optional further actives (safener C and/or herbicide D) can be applied simultaneously or in succession.

The compositions are applied to the plants mainly by spraying, in particular foliar spraying. Application can be carried out by customary spraying techniques using, for example, water as carrier and spray liquor rates of from about 10 to 2000 I/ha or 50 to 1000 I/ha (for example from 100 to 500 I/ha). Application of the herbicidal compositions by the low-volume and the ultra-low-volume method is possible, as is their application in the form of microgranules.

If the active ingredients are less well tolerated by certain crop plants, application techniques may be used in which the herbicidal compositions are sprayed, with the aid of the spray apparatus, in such a way that they come into as little contact, if any, with the leaves of the sensitive crop plants while reaching the leaves of undesirable plants which grow underneath, or the bare soil (post-directed, lay-by).

In the case of a post-emergence treatment of the plants, the herbicidal mixtures or compositions according to the invention are preferably applied by foliar application. Application may be effected, for example, by usual spraying techniques with water as the carrier, using amounts of spray mixture of approx. 50 to 1000 I/ha.

The required application rate of the composition of the pure active compounds, i.e. of pyroxasulfone, herbicide B and optionally safener or herbicide D depends on the density of the undesired vegetation, on the development stage of the plants, on the climatic conditions of the location where the composition is used and on the application method. In general, the application rate of the composition (total amount of pyroxasulfone, herbicide B and optional further actives) is from 15 to 5000 g/ha, preferably from 20 to 2500 g/ha of active substance.

The required application rates of pyroxasulfone are generally in the range from 1 g/ha to 500 g/ha and preferably in the range from 5 g/ha to 400 g/ha or from 10 g/ha to 300 g/ha of active substance.

The required application rates of the herbicide B (total amount of herbicide B) are generally in the range from 0.1 g/ha to 5000 g/ha and preferably in the range from 1 g/ha to 2500 g/ha or from 5 g/ha to 2000 g/ha of active substance.

The required application rates of the safener, if applied, are generally in the range from 1 g/ha to 5000 g/ha and preferably in the range from 2 g/ha to 5000 g/ha or from 5 g/ha to 5000 g/ha of active substance. Preferably no safener or virtually no safener is applied and thus the application rates are below 5 g/ha, in particular below 2 g/ha or below 1 g/ha.

According to a first embodiment of the invention, the component b) comprises at least one phenyluracil herbicide or a pyrazole herbicide. More specifically the component b) according to this embodiment comprises at least one compound of the formula I as defined above or a salt thereof, or at least one compound of the formula I′ as defined above or a salt thereof.

Preferred compounds of formula I are the compounds of the formula Ia and more preferably the compounds of the formula Ia which are selected from butafenacil and saflufenacil.

Likewise preferred compounds of the formula I, are the compounds of the formula Ib, in particular the compounds of the formula Ib, wherein
R² is fluorine, R⁴ is chlorine, R⁵ is methyl and R^{1a} is cyclopropylmethyl,
R² is chlorine, R⁴ is chlorine, R⁵ is methyl and R^{1a} is cyclopropylmethyl,
R² is fluorine, R⁴ is chlorine, R⁵ is methyl and R^{1a} is methyl,
R² is chlorine, R⁴ is chlorine, R⁵ is methyl and R^{1a} is methyl,
R² is fluorine, R⁴ is chlorine, R⁵ is methyl and R^{3a} is ethyl,
R² is chlorine, R⁴ is chlorine, R⁵ is methyl and R^{1a} is ethyl,
R² is fluorine, R⁴ is chlorine, R⁵ is methyl and R^{1a} is trifluoromethyl or
R² is chlorine, R⁴ is chlorine, R⁵ is methyl and R^{1a} is trifluoromethyl.

Likewise preferred compounds of the formula I, are the compounds of the formula Id, in particular the compounds of the formula Id, wherein
R² is fluorine, R⁴ is chlorine, R⁵ is methyl and R^{3b} is cyclopropylmethyl,
R² is chlorine, R⁴ is chlorine, R⁵ is methyl and R^{3b} is cyclopropylmethyl,
R² is fluorine, R⁴ is chlorine, R⁵ is methyl and R^{3b} is methyl,
R² is chlorine, R⁴ is chlorine, R⁵ is methyl and R^{3b} is methyl,
R² is fluorine, R⁴ is chlorine, R⁵ is methyl and R^{3b} is ethyl,
R² is chlorine, R⁴ is chlorine, R⁵ is methyl and R^{3b} is ethyl,
R² is fluorine, R⁴ is chlorine, R⁵ is methyl and R^{3b} is trifluoromethyl or
R² is chlorine, R⁴ is chlorine, R⁵ is methyl and R^{3b} is trifluoromethyl.

Preferred compounds of formula I′ are the compounds of the formula Ic and more preferably the compounds of the formula Ic, wherein
R² is fluorine, R⁴ is chlorine, R⁵ is methyl, R⁶ is difluoromethoxy, R⁷ is chlorine and R^{3a} is ethyl,
R² is chlorine, R⁴ is chlorine, R⁵ is methyl, R⁶ is difluoromethoxy, R⁷ is chlorine and R^{3a} is ethyl,
R² is fluorine, R⁴ is chlorine, R⁵ is methyl, R⁶ is difluoromethoxy, R⁷ is bromine and R^{3a} is ethyl, or
R² is chlorine, R⁴ is chlorine, R⁵ is methyl, R⁶ is difluoromethoxy, R⁷ is bromine and R^{3a} is ethyl.

Preferred compounds of formula I′ are also the compounds of the formula Ie and more preferably the compounds of the formula Ie which are selected from fluazolate and pyraflufen-ethyl.

In particular preferred compositions of this embodiment, the herbicide B comprises or in particular is butafenacil.

In other particular preferred compositions of this embodiment, the herbicide B comprises or in particular is saflufenacil.

In other particular preferred compositions of this embodiment, the herbicide B comprises or in particular is a compound of the formula Ib, wherein R² is fluorine, R⁴ is chlorine, R⁵ is methyl and R^{3a} is cyclopropylmethyl.

In other particular preferred compositions of this embodiment, the herbicide B comprises or in particular is a compound of the formula Id, wherein R² is fluorine, R⁴ is chlorine, R⁵ is methyl and R^{3b} is trifluoromethyl.

In other particular preferred compositions of this embodiment, the herbicide B comprises or in particular is a compound of the formula Ic, wherein R² is chlorine, R⁴ is chlorine, R⁵ is methyl, R⁶ is difluoromethoxy, R⁷ is bromine and R^{3a} is ethyl.

In other particular preferred compositions of this embodiment, the herbicide B comprises or in particular is a compound of the formula Ic, wherein R² is fluorine, R⁴ is chlorine, R⁵ is methyl, R⁶ is difluoromethoxy, R⁷ is chlorine and R^{1a} is ethyl.

In particular preferred compositions of this embodiment, the herbicide B comprises or in particular is fluazolate.

In other particular preferred compositions of this embodiment, the herbicide B comprises or in particular is pyraflufen-ethyl.

In this embodiment the relative weight ratio of pyroxasulfone and an herbicide of formula I or I′, respectively, is preferably from 1:100 to 100:1 and more preferably from 50:1 to 1:50.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the herbicides of formula I or I′, respectively, is usually 0.1 to 500 g/ha, as a rule 1 to 400 g/ha, preferably 5 to 300 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Digitaria spec., Echinochloa spec., Eleusine indica, Lolium spec., Phalaris spec., Poa annua, Setaria spec., Abuthilon theoprasti, Amaranthus spec., Ambrosia spec., Brassica kaber, Capsella bursa-pastoris, Cassia spec., Chenopodium spec., Convolvolus spec., Conyza spec., Euphorbia spec., Galium aparine, Geranium spec., Ipomoea spec., Kochia scoparia, Malva spec., Matricaria spec., Mercurialis annua, Polygonum spec., Raphanus raphanistrum, Sida spec., Sinapis arvensis, Solanum spec., Sysimbrium spec., Thlaspi arvense, Xanthium spec. and Commelina spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, pomefruit such as apple and pear, stonefruit, such as peach, almond, walnut, olive, cherry, plum and apricot, citrus and pistachio.

The compositions of this embodiment are most suitable for application in wheat, barley, rye, rice, corn, sugarcane, sorghum, pulse crops, sunflower, turf, grapes, stonefruit, citrus and pistachio.

The compositions of this embodiment can preferably be used in crops which tolerate and/or are resistant to the action of PPO herbicides, preferably in crops which tolerate and/or are resistant to the action of formula I herbicides. The resistance and or tolerance to said herbicides may be achieved by conventional breeding and/or by genetic engineering methods.

If not stated otherwise, the compositions of this embodiment are suitable for application in any variety of the aforementioned crop plants.

According to a second embodiment of the invention, the component b) comprises at least one triazolone or oxadiazolone herbicide. More specifically the component b) according to this embodiment comprises at least one compound of the formula II as defined above.

Preferred compounds of formula II include azafenidin, carfentrazone, sulfentrazone, oxadiazon and oxadiargyl. Also included are the salts of carfentrazone, in particular its sodium salt, potassium salt, ammonium salt or substituted ammonium salts as defined above, in particular mono-, di and tri-C₁-C₈-alkylammonium salts such as isopropylammonium salts and the esters of carfentrazone, in particular its C₁-C₈-alkyl esters, such as methylesters, ethylesters, isopropyl esters. A suitable example of such an ester is carfentrazone-ethyl.

In particular preferred compositions of this embodiment, the herbicide B comprises or in particular is azafenidin.

In other particular preferred compositions of this embodiment, the herbicide B comprises or in particular is carfentrazone or a salt or ester thereof.

In further particular preferred compositions of this embodiment, the herbicide B comprises or in particular is sulfentrazone.

In further particular preferred compositions of this embodiment, the herbicide B comprises or in particular is oxadiazon.

In further particular preferred compositions of this embodiment, the herbicide B comprises or in particular is oxadiargyl.

In this embodiment the relative weight ratio of pyroxasulfone and an herbicide of formula II is preferably from 100:1 to 1:100, in particular from 50:1 to 1:50.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the formula II herbicide is usually 0.1 to 5000 g/ha, as a rule 1 to 2500 g/ha, preferably 5 to 2000 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Cenchrus spec., Digitaria spec., Echinochloa spec., Eleusine indica, Lolium spec., Panicum spec., Phalaris spec., Poa annua, red rice, Setaria spec., Amaranthus spec., Cassia spec., Chenopodium spec., Convolvolus spec., Euphorbia spec., Galium aparine, Ipomoea spec., Kochia scoparia, Malva spec., Polygonum spec., Raphanus raphanistrum, Sida spec., Solanum spec., Sonchus arvensis, Veronica spec., Viola spec., Commelina spec. and Cyperus spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus, pistachio, onion, garlic and deciduous trees.

The compositions of this embodiment are most suitable for application in wheat, barley, rye, durum, rice, sugarcane, soybeans, cotton, sunflower, potato, grapes, stonefruit, citrus and pistachio.

If not stated otherwise, the compositions of this embodiment are suitable for application in any variety of the aforementioned crop plants.

The compositions of this embodiment can preferably be used in crops which tolerate and/or are resistant to the action of PPO herbicides, preferably in crops which tolerate and/or are resistant to the action of formula II herbicides. The resistance and or tolerance to said herbicides may be achieved by conventional breeding and/or by genetic engineering methods.

According to a third embodiment of the invention, the component b) comprises at least one dicarboximide herbicide. More specifically the component b) according to this embodiment comprises at least one compound of the formula III as defined above.

Preferred compounds of formula III include cinidon, flumioxazin, flumiclorac, and flumipropyn. Also included are the salts of cinidon and flumiclorac, in particular their sodium salts, potassium salts, ammonium salts or substituted ammonium salts as defined above, in particular mono-, di and tri-C₁-C₈-alkylammonium salts such as isopropylammonium salts, and the esters of cinidon and flumiclorac, in particular their C₁-C₈-alkyl esters, such as methylesters, ethylesters, isopropyl esters. Suitable examples of such esters are cinidon-ethyl and flumiclorac-pentyl.

In preferred compositions of this embodiment, the herbicide B comprises or in particular is cinidon, flumioxazin, flumiclorac, or flumipropyn, or a salt or an ester of cinidon or flumiclorac.

In a particular preferred composition of this embodiment, the herbicide B comprises or in particular is flumioxazin.

In another particular preferred composition of this embodiment, the herbicide B comprises or in particular is flumiclorac.

In a further particular preferred composition of this embodiment, the herbicide B comprises or in particular is flumipropyn.

In this embodiment the relative weight ratio of pyroxasulfone and an herbicide of the group b.3 is preferably from 100:1 to 1:100, in particular from 50:1 to 1:50.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the formula III herbicide is usually 0.1 to 1000 g/ha, as a rule 1 to 750 g/ha, preferably 5 to 500 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Digitaria spec., Echinochloa spec., Eleusine indica, Lolium spec., Phalaris spec., Poa annus, Setaria spec., Amaranthus spec., Cassia spec., Chenopodium spec., Conyza spec., Euphorbia spec., Galium aparine, Geranium spec., Ipomoea spec., Lamium spec., Malva spec., Matricaria spec., Papaver thoeas, Sida spec., Solanum spec., Stellaria media, Veronica spec., Viola spec. and Commelina spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus and pistachio.

The compositions of this embodiment are most suitable for application in wheat, barley, rye, triticale, durum, rice, sugarcane, soybeans, peanuts, potato, turf, grapes, stonefruit, citrus and pistachio.

If not stated otherwise, the compositions of this embodiment are suitable for application in any variety of the aforementioned crop plants.

The compositions of this embodiment can preferably be used in crops which tolerate and/or are resistant to the action of PPO herbicides, preferably in crops which tolerate and/or are resistant to the action of formula III herbicides. The resistance and or tolerance to said herbicides may be achieved by conventional breeding and/or by genetic engineering methods.

According to a fourth embodiment of the invention, the component b) comprises at least one nitrophenylether herbicide. More specifically the component b) according to this embodiment comprises at least one compound of the formula IV as defined above.

Preferred compounds of formula IV include nitrofen, bifenox, oxyfluorfen, acifluorfen, fluoroglycofen, fomesafen, lactofen, halosafen, chlornitrofen, fluornitrofen, chlomethoxyfen and nitrofluorfen. Also included are the salts of acifluorfen and fluoroglycofen, in particular the sodium salts, potassium salts, ammonium salts or substituted ammonium salts as defined above, in particular mono-, di and tri-C₁-C₈-alkylammonium salts such as isopropylammonium salts and the esters of acifluorfen and fluoroglycofen, in particular their C₁-C₈-alkyl esters, such as methylesters, ethylesters, isopropyl esters. A suitable example of such a salt is acifluorfen-sodium. Suitable examples of such esters are acifluorfen-methyl and fluoroglycofen-ethyl.

In preferred compositions of this embodiment, the herbicide B comprises or in particular is include nitrofen, bifenox, oxyfluorfen, acifluorfen, fluoroglycofen, fomesafen, lactofen, halosafen, chlornitrofen, fluornitrofen, chlomethoxyfen and nitrofluorfen, acifluorfen-sodium, or a salt or an ester of acifluorfen or fluoroglycofen.

In a particular preferred composition of this embodiment, the herbicide B comprises or in particular is oxyfluorfen.

In this embodiment the relative weight ratio of pyroxasulfone and an herbicide of formula IV is preferably from 100:1 to 1:300, in particular from 50:1 to 1:200.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the formula IV herbicide is usually 1 to 5000 g/ha, as a rule 5 to 4000 g/ha, preferably 10 to 2000 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Digitaria spec., Echinochloa spec., Eleusine indica, Lolium spec., Phalaris spec., Poa annus, Setaria spec., Abuthilon theoprasti, Amaranthus spec., Atriplex spec., Chenopodium spec., Datura spec., Euphorbia spec., Galium aparine, Ipomoea spec., Lamium spec., Polygonum spec., Veronica spec., Viola spec., Xanthium spec. and Commelina spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus, pistachio, onion, garlic and deciduous trees.

The compositions of this embodiment are most suitable for application in wheat, barley, rice, sugarcane, soybean, pulse crops, peanuts, brassica crops, grapes, stonefruit, citrus and pistachio.

If not stated otherwise, the compositions of this embodiment are suitable for application in any variety of the aforementioned crop plants.

The compositions of this embodiment can preferably be used in crops which tolerate and/or are resistant to the action of PPO herbicides, preferably in crops which tolerate and/or are resistant to the action of formula IV herbicides. The resistance and or tolerance to said herbicides may be achieved by conventional breeding and/or by genetic engineering methods.

According to a fifth embodiment of the invention, the component b) comprises at least one triazindione herbicide. More specifically the component b) according to this embodiment comprises at least one compound of the formula V as defined above.

In a preferred compound of formula V the variable Y is S, R²³ is fluorine, R²⁴ is propargyl, R²⁵ is methyl and R²⁶ is methyl.

In this embodiment the relative weight ratio of pyroxasulfone and an herbicide of formula V is preferably from 100:1 to 1:100, in particular from 50:1 to 1:50.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the formula V herbicide is usually 0.1 to 5000 g/ha, as a rule 1 to 2500 g/ha, preferably 5 to 2000 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Cenchrus spec., Digitaria spec., Echinochloa spec., Eleusine indica, Lolium spec., Panicum spec., Phalaris spec., Poa annua, red rice, Setaria spec., Amaranthus spec., Cassia spec., Chenopodium spec., Convolvolus spec., Euphorbia spec., Galium aparine, Ipomoea spec., Kochia scoparia, Malva spec., Polygonum spec., Raphanus raphanistrum, Sida spec., Solanum spec., Sonchus arvensis, Veronica spec., Viola spec., Commelina spec. and Cyperus spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus, pistachio, onion, garlic and deciduous trees.

The compositions of this embodiment are most suitable for application in wheat, barley, rye, durum, rice, sugarcane, soybeans, cotton, sunflower, potato, grapes, stonefruit, citrus and pistachio.

If not stated otherwise, the compositions of this embodiment are suitable for application in any variety of the aforementioned crop plants.

The compositions of this embodiment can preferably be used in crops which tolerate and/or are resistant to the action of PPO herbicides, preferably in crops which tolerate and/or are resistant to the action of formula V herbicides. The resistance and or tolerance to said herbicides may be achieved by conventional breeding and/or by genetic engineering methods.

According to a sixth embodiment of the invention, the component b) comprises at least one dicarboxamide herbicide. More specifically the component b) according to this embodiment comprises at least one compound of the formula VI as defined above.

A particular preferred compound of the formula VI is the compound of the formula VIa.

In this embodiment the relative weight ratio of pyroxasulfone and an herbicide of formula V1 is preferably from 100:1 to 1:100, in particular from 50:1 to 1:50.

The rate of application of pyroxasulfone is usually from 1 g/ha to 500 g/ha and preferably in the range from 5 g/ha to 400 g/ha or from 10 g/ha to 300 g/ha of active substance (a.s.).

The rate of application of the formula VI herbicide is usually 0.1 to 5000 g/ha, as a rule 1 to 2500 g/ha, preferably 5 to 2000 g/ha, of active substance (a.s.).

The compositions of this embodiment are particularly suitable for controlling mono- and dicotyledonous weeds and sedge weeds, in particular Alopecurus myosuroides, Apera spica-venti, Avena fatua, Brachiaria spec., Bromus spec., Cenchrus spec., Digitaria spec., Echinochloa spec., Eleusine indica, Lolium spec., Panicum spec., Phalaris spec., Poa annua, red rice, Setaria spec., Amaranthus spec., Cassia spec., Chenopodium spec., Convolvolus spec., Euphorbia spec., Galium aparine, Ipomoea spec., Kochia scoparia, Malva spec., Polygonum spec., Raphanus raphanistrum, Sida spec., Solanum spec., Sonchus arvensis, Veronica spec., Viola spec., Commelina spec. and Cyperus spec.

The compositions of this embodiment are in particular suitable for combating undesired vegetation in wheat, barley, rye, triticale, durum, rice, corn, sugarcane, sorghum, soybean, pulse crops such as pea, bean and lentils, peanut, sunflower, sugarbeet, potato, cotton, brassica crops, such as oilseed rape, canola, mustard, cabbage and turnip, turf, grapes, stonefruit, such as peach, almond, walnut, olive, cherry, plum and apricot, citrus, pistachio, onion, garlic and deciduous trees.

The compositions of this embodiment are most suitable for application in wheat, barley, rye, durum, rice, sugarcane, soybeans, cotton, sunflower, potato, grapes, stonefruit, citrus and pistachio.

If not stated otherwise, the compositions of this embodiment are suitable for application in any variety of the aforementioned crop plants.

The compositions of this embodiment can preferably be used in crops which tolerate and/or are resistant to the action of PPO herbicides, preferably in crops which tolerate and/or are resistant to the action of formula V herbicides. The resistance and or tolerance to said herbicides may be achieved by conventional breeding and/or by genetic engineering methods.

The present invention also relates to formulations of the compositions according to the present invention. The formulations contain, besides the composition, at least one organic or inorganic carrier material. The formulations may also contain, if desired, one or more surfactants and, if desired, one or more further auxiliaries customary for crop protection compositions.

The formulation may be in the form of a single package formulation containing both the herbicide A and the at least one herbicide B together with liquid and/or solid carrier materials, and, if desired, one or more surfactants and, if desired, one or more further auxiliaries customary for crop protection compositions. The formulation may be in the form of a two package formulation, wherein one package contains a formulation of pyroxasulfone while the other package contains a formulation of the at least one herbicide B and wherein both formulations contain at least one carrier material, if desired, one or more surfactants and, if desired, one or more further auxiliaries customary for crop protection compositions. In the case of two package formulations the formulation containing pyroxasulfone and the formulation containing the herbicide B are mixed prior to application. Preferably the mixing is performed as a tank mix, i.e. the formulations are mixed immediately prior or upon dilution with water. If the compositions of the invention comprise one or more further actives such as a safener and/or a herbicide D, the compositions may also be in the form of three or four package formulations.

In the formulation of the present invention the active ingredients, i.e. pyroxasulfone, herbicide B and optional further actives are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof. Solid carriers include e.g. mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF SE), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF SE, Sokalan types), polyalkoxylates, polyvinylamine (BASF SE, Lupamine types), polyethyleneimine (BASF SE, Lupasol types), polyvinylpyrrolidone and copolymers thereof.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on dichlorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide MBS from Thor Chemie).

Examples of antifreeze agents are ethylene glycol, propylene glycol, urea or glycerol.

Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

To prepare emulsions, pastes or oil dispersions, the active the components, as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Powders, materials for spreading and dusts can be prepared by mixing or concomitant grinding of the active the components a) and b) and optionally safener c) and/or herbicide D with a solid carrier.

Granules, e.g. coated granules, impregnated granules and homogeneous granules, can be prepared by binding the active ingredients to solid carriers.

The formulations of the invention comprise a herbicidally effective amount of the composition of the present invention. The concentrations of the active ingredients in the formulations can be varied within wide ranges. In general, the formulations comprise from 1 to 98% by weight, preferably 10 to 60% by weight, of active ingredients (sum of pyroxasulfone, herbicide B and optionally further actives). The active ingredients are employed in a purity of from 90% to 100%, preferably 95% to 100% (according to NMR spectrum).

The active compounds A and B and optionally further actives as well as the compositions according to the invention can, for example, be formulated as follows:

1. Products for dilution with water
A Water-soluble concentrates

10 parts by weight of active compound (or composition) are dissolved in 90 parts by weight of water or a water-soluble solvent. As an alternative, wetters or other adjuvants are added. The active compound dissolves upon dilution with water. This gives a formulation with an active compound content of 10% by weight.

B Dispersible concentrates

20 parts by weight of active compound (or composition) are dissolved in 70 parts by weight of cyclohexanone with addition of 10 parts by weight of a dispersant, for example polyvinylpyrrolidone. Dilution with water gives a dispersion. The active compound content is 20% by weight.

C Emulsifiable concentrates

15 parts by weight of active compound (or composition) are dissolved in 75 parts by weight of an organic solvent (e.g. alkylaromatics) with addition of calcium dodecylbenzenesulfonate and castor oil ethoxylate (in each case 5 parts by weight). Dilution with water gives an emulsion. The formulation has an active compound content of 15% by weight.

### D Emulsions

25 parts by weight of active compound (or composition) are dissolved in 35 parts by weight of an organic solvent (e.g. alkylaromatics) with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active compound content of 25% by weight.

### E Suspensions

In an agitated ball mill, 20 parts by weight of active compound (or composition) are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-dispersible granules and water-soluble granules

50 parts by weight of active compound (or composition) are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders

75 parts by weight of active compound (or composition) are ground in a rotor-stator mill with addition of 25 parts by weight of dispersants, wetters and silica gel. Dilution with water gives a stable dispersion or solution of the active compound. The active compound content of the formulation is 75% by weight.

### H Gel Formulations

In a ball mill, 20 parts by weight of active compound (or composition), 10 parts by weight of dispersant, 1 part by weight of gelling agent and 70 parts by weight of water or of an organic solvent are mixed to give a fine suspension. Dilution with water gives a stable suspension with active compound content of 20% by weight.

2. Products to be applied undiluted

### I Dusts

5 parts by weight of active compound (or composition) are ground finely and mixed intimately with 95 parts by weight of finely divided kaolin. This gives a dusting powder with an active compound content of 5% by weight.

### J Granules (GR, FG, GG, MG)

0.5 parts by weight of active compound (or composition) are ground finely and associated with 99.5 parts by weight of carriers. Current methods here are extrusion, spray-drying or the fluidized bed. This gives granules to be applied undiluted with an active compound content of 0.5% by weight.

K ULV solutions (UL)

10 parts by weight of active compound (or composition) are dissolved in 90 parts by weight of an organic solvent, for example xylene. This gives a product to be applied undiluted with an active compound content of 10% by weight.

Aqueous use forms can be prepared from emulsion concentrates, suspensions, pastes, wettable powders or water-dispersible granules by adding water.

It may furthermore be beneficial to apply the compositions of the invention alone or in combination with other herbicides, or else in the form of a mixture with other crop protection agents, for example together with agents for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

### USE EXAMPLES

The effect of the herbicidal compositions according to the invention of herbicides A and B and, if appropriate, safener on the growth of undesirable plants compared to the herbicidally active compounds alone was demonstrated by the following greenhouse experiments:

For the pre-emergence treatment, directly after sowing the active compounds, which had been suspended or emulsified in water, were applied by means of finely distributed nozzles. The containers were irrigated gently to promote germination and growth and subsequently covered with transparent plastic hoods until plant had rooted. This cover caused uniform germination of the tests plants, unless this was adversely affected by active compounds.

For the post-emergence treatment, the test plants were first grown to a height of 3 to 20 cm, depending on the plant habit, and only then treated. Here, the herbicidal compositions were suspended or emulsified in water as distribution medium and sprayed using finely distributing nozzles.

The respective herbicides A and/or safener were formulated as 10% by weight strength suspension concentrate and introduced to the spray liquor with the amount of solvent system used for applying the active compound. Herbicide B and/or safener were used as commercially available formulations and introduced to the spray liquor with the amount of solvent system used for applying the active compound. In the examples, the solvent used was water.

Pyroxasulfone was used either as an aqueous suspension concentrate having an active ingredient concentration of 100 g/l or as an emulsifiable concentrate having an active ingredient concentration of 50 g/l.

Saflufenacil was used as a wettable granule formulation having an active ingredient content of 70% by weight.

The compound of the formula Ic, where R² is chlorine, R⁴ is chlorine, R^{1a} is ethyl, R⁶ is difluoromethoxy and R⁷ is bromine, was used as an emulsifiable concentrate having an active ingredient concentration of 50 g/l. This compound is also termed as compound Ic-1.

The compound of the formula V, where R²³ is fluorine, R²⁴ is propargyl, R²⁵ is methyl, R²⁶ is methyl and Y is S, was used as an emulsifiable concentrate having an active ingredient concentration of 50 g/l. This compound is also termed as compound V-1.

The test period extended over 21 days. During this time, the plants were tended, and their response to the treatments with active compound was evaluated.

The evaluation for the damage caused by the chemical compositions was carried out using a scale from 0 to 100%, compared to the untreated control plants. Here, 0 means no damage and 100 means complete destruction of the plants.

The plants used in the greenhouse experiments belonged to the following species:

| Scientific Name | Code | Common Name |
|---|---|---|
| Abutilon theophrasti | ABUTH | velvetleaf |
| Agropyron repens | AGRRE | quackgrass |
| Alopecurus myosuroides | ALOMY | blackgrass |
| Amaranthus retroflexus | AMARE | pig weed |
| Ambrosia artemisifolia | AMBEL | common ragweed |
| Apera spica-venti | APESV | windgrass |
| Avena fatua | AVEFA | wild oat |
| Brachiaria plantaginea | BRAPL | alexandergrass |
| Bromus inermis | BROIN | awnless brome |
| Bromus sterilis | BROST | sterile brome |
| Brassica napus spp. napus | BRSNW | winter oilseed-rape |
| Capsella bursa-pastoris | CAPBP | sheperd's-purse |
| Cenchrus echinatus | CCHEC | sandbur |
| Chenopodium album | CHEAL | lambsquarter |
| Commelina benghalensis | COMBE | tropical spiderwort |
| Digitaria sanguinalis | DIGSA | large crabgrass |
| Echinochloa crus-galli | ECHCG | barnyardgrass |
| Eleusine indica | ELEIN | goosegrass |
| Galium aparine | GALAP | cleaver |
| Glycine max | GLXMA | soybean |
| Gossypium hirsutum | GOSHI | cotton |
| Helianthus annuus | HELAN | sunflower |
| Hordeum vulgare | HORVW | winter barley |
| Kochia scoparia | KCHSC | kochia |
| Lamium purpureum | LAMPU | red deadnettle |
| Lolium multiflorum | LOLMU | italian ryegrass |
| Matricaria inermis | MATIN | scentless mayweed |
| Mercurialis annua | MERAN | annual mercury |
| Orysa sativa | ORYSA | rice |
| Panicum dichotomiflorum | PANDI | fall panicum |
| Panicum milliaceum | PANMI | proso millet |
| Phalaris canariensis | PHACA | canarygrass |
| Ipomoea purpurea | PHBPU | tall morningglory |
| Poa annua | POAAN | annual bluegrass |
| Polygonum convolvulus | POLCO | wild buckwheat |
| Secale cereale | SECCW | winter rye |
| Setaria faberii | SETFA | giant foxtail |
| Setaria italica | SETIT | foxtail millet |
| Setaria lutescens | SETLU | yellow foxtail |
| Setaria viridis | SETVI | green foxtail |
| Solanum nigrum | SOLNI | black nightshade |
| Sorghum halepense | SORHA | johnsongrass |
| Stellaria media | STEME | chickweed |
| Thlaspi arvense | THLAR | field pennycress |
| Triticum aestivum | TRZAS | spring wheat |
| Triticum aestivum | TRZAW | winter wheat |
| Veronica persica | VERPE | field speedwell |
| Viola arvensis | VIOAR | field pansy |
| Xanthium strumarium | XANST | cocklebur |
| Zea mays | ZEAMX | corn |

Colby's formula was applied to determine whether the composition showed synergistic action. The value E, which is to be expected if the activity of the individual compounds is just additive, was calculated using the method of S. R. Colby (1967) “Calculating synergistic and antagonistic responses of herbicide combinations”, Weeds 15, p. 22 ff.

E=X+Y−(X·Y/100)

where
X=effect in percent using herbicide A at an application rate a;
Y=effect in percent using herbicide B at an application rate b;
E=expected effect (in %) of A+B at application rates a+b.

If the value observed in this manner is higher than the value E calculated according to Colby, a synergistic effect is present.

An accelerated activity is observed when the damage 7 or 8 days after treatment (7 DAT or 8 DAT) achieved by the combination shows a synergistic effect.

Table 1a relates to the herbicidal activity of the individual actives in pre-emergence application assessed 8 DAT and 20 DAT. Table 1b relates the herbicidal activity of the combined actives in pre-emergence application assessed 8 DAT and 20 DAT.

Table 2a relates to the herbicidal activity of the individual actives in post-emergence application assessed 8 DAT and 20 DAT. Table 2b relates the herbicidal activity of the combined actives in post-emergence application assessed 8 DAT and 20 DAT.

Tables 3 and 4 relate to the herbicidal activity of the individual actives and of the combinations in post-emergence application assessed 20 DAT.

TABLE 1a
Application in Pre-Emergence of pyroxasulfone
and saflufenacil (individual activities)

| | pyroxasulfone (A) | | | saflufenacil (B) | | |
|---|---|---|---|---|---|---|
| | use rate | observed % activity | | use rate g ai/ha | observed % activity | |
| weed | [g ai/ha] | 8 DAT¹⁾ | 20 DAT¹⁾ | [g ai/ha] | 8 DAT¹⁾ | 20 DAT¹⁾ |
| SETFA | 50 | 90 | 98 | 12.5 | 20 | 35 |
| SETFA | 25 | 85 | 98 | 6.25 | 0 | 35 |
| SETIT | 25 | 75 | 98 | 25 | 40 | 55 |
| ALOMY | 50 | 90 | 98 | 12.5 | 30 | 30 |
| BROIN | 25 | 60 | 75 | 3.13 | 0 | 0 |
| SORHA | 25 | 75 | 95 | 3.13 | 0 | 0 |
| CHEAL | 50 | 70 | 98 | 3.13 | 75 | 60 |
| CHEAL | 25 | 65 | 95 | 3.13 | 75 | 60 |
| PHBPU | 25 | 40 | 50 | 6.25 | 80 | 80 |
| PHBPU | 50 | 65 | 90 | 3.13 | 45 | 50 |
| AMBEL | 50 | 50 | 80 | 12.5 | 70 | 80 |
| AMBEL | 25 | 40 | 65 | 12.5 | 70 | 80 |
| MATIN | 50 | 20 | 85 | 6.25 | 95 | 98 |
| MATIN | 25 | 0 | 60 | 6.25 | 95 | 98 |
| GALAP | 50 | 70 | 90 | 3.13 | 40 | 40 |
| GALAP | 25 | 50 | 80 | 3.13 | 40 | 40 |
| KCHSC | 25 | 40 | 98 | 12.5 | 75 | 80 |

TABLE 1b
Application in Pre-Emergence of pyroxasulfone and saflufenacil (combined activities)

| | pyroxasulfone + saflufenacil | | | | | Synergism | |
|---|---|---|---|---|---|---|---|
| | use rate | Observed % activity | | expected % activity | | Y/N | Y/N |
| weed | [g ai/ha] | 8 DAT¹⁾ | 20 DAT¹⁾ | 8 DAT²⁾ | 20 DAT²⁾ | 8 DAT³⁾ | 20 DAT³⁾ |
| SETFA | 50 + 12.5 | 95 | 100 | 92 | 99 | Y | Y |
| SETFA | 25 + 6.25 | 90 | 100 | 85 | 99 | Y | Y |
| SETIT | 25 + 25 | 95 | 100 | 85 | 99 | Y | Y |
| ALOMY | 50 + 12.5 | 95 | 100 | 93 | 99 | Y | Y |
| BROIN | 25 + 3.125 | 70 | 85 | 60 | 75 | Y | Y |
| SORHA | 25 + 3.125 | 85 | 100 | 75 | 95 | Y | Y |
| CHEAL | 50 + 3.125 | 95 | 100 | 93 | 99 | Y | Y |
| CHEAL | 25 + 3.125 | 95 | 100 | 91 | 98 | Y | Y |
| PHBPU | 25 + 6.25 | 90 | 100 | 88 | 90 | Y | Y |
| PHBPU | 50 + 3.125 | 90 | 100 | 81 | 95 | Y | Y |
| AMBEL | 50 + 12.5 | 95 | 100 | 85 | 96 | Y | Y |
| AMBEL | 25 + 12.5 | 90 | 98 | 82 | 93 | Y | Y |
| MATIN | 50 + 6.25 | 98 | 100 | 96 | 100 | Y | Y |
| MATIN | 25 + 6.25 | 98 | 100 | 95 | 99 | Y | Y |
| GALAP | 50 + 3.125 | 95 | 95 | 82 | 94 | Y | Y |
| GALAP | 25 + 3.125 | 90 | 90 | 70 | 88 | Y | Y |
| KCHSC | 25 + 12.5 | 95 | 100 | 85 | 100 | Y | Y |

¹⁾observed activity in % destruction 8 or 20 days after treatment
²⁾calculated from the individual activities by Colby's formula
³⁾Synergism: Y = Yes; N = No

TABLE 2a
Application in Post-Emergence of pyroxasulfone
and saflufenacil (individual activities)

| | pyroxasulfone (A) | | | saflufenacil (B) | | |
|---|---|---|---|---|---|---|
| | use rate | observed % activity | | use rate g ai/ha | observed % activity | |
| weed | [g ai/ha] | 8 DAT¹⁾ | 20 DAT¹⁾ | [g ai/ha] | 8 DAT¹⁾ | 20 DAT¹⁾ |
| ECHCG | 13 | 25 | 80 | 13 | 15 | 0 |
| ECHCG | 13 | 25 | 80 | 6.25 | 10 | 0 |
| ECHCG | 13 | 25 | 80 | 1.6 | 10 | 0 |
| SETLU | 13 | 0 | 65 | 1.6 | 30 | 10 |
| ALOMY | 100 | 40 | 75 | 13 | 35 | 15 |
| ALOMY | 100 | 40 | 75 | 6.25 | 20 | 0 |
| ALOMY | 13 | 0 | 15 | 1.6 | 0 | 0 |
| SORHA | 50 | 65 | 90 | 1.6 | 20 | 35 |
| SETIT | 100 | 45 | 80 | 6.25 | 30 | 20 |
| SETIT | 50 | 25 | 75 | 3.1 | 30 | 15 |
| CHEAL | 50 | 60 | 65 | 13 | 45 | 35 |
| CHEAL | 50 | 60 | 65 | 6.25 | 35 | 35 |
| CHEAL | 13 | 35 | 25 | 6.25 | 35 | 35 |
| POLCO | 100 | 50 | 55 | 13 | 95 | 98 |
| POLCO | 100 | 50 | 55 | 1.6 | 35 | 30 |
| POLCO | 50 | 50 | 50 | 1.6 | 35 | 30 |
| POLCO | 25 | 30 | 50 | 1.6 | 35 | 30 |
| SOLNI | 100 | 75 | 90 | 13 | 85 | 85 |
| SOLNI | 13 | 75 | 75 | 13 | 85 | 85 |
| XANST | 100 | 25 | 55 | 6.25 | 70 | 80 |
| XANST | 25 | 20 | 25 | 6.25 | 70 | 80 |
| XANST | 13 | 0 | 0 | 3.1 | 70 | 75 |
| XANST | 100 | 25 | 55 | 1.6 | 35 | 45 |
| GALAP | 100 | 70 | 90 | 13 | 80 | 70 |
| GALAP | 25 | 60 | 85 | 6.25 | 35 | 30 |
| GALAP | 100 | 70 | 90 | 3.1 | 25 | 20 |
| GALAP | 25 | 60 | 85 | 3.1 | 25 | 20 |
| GALAP | 100 | 70 | 90 | 1.6 | 15 | 20 |
| GALAP | 25 | 60 | 85 | 1.6 | 15 | 20 |
| KCHSC | 100 | 60 | 70 | 6.25 | 60 | 30 |
| KCHSC | 13 | 60 | 50 | 6.25 | 60 | 30 |

TABLE 2b
Application in Post-Emergence of pyroxasulfone and saflufenacil (combined activities)

| | pyroxasulfone + saflufenacil | | | | | Synergism | |
|---|---|---|---|---|---|---|---|
| | use rate | Observed % activity | | expected % activity | | Y/N | Y/N |
| weed | [g ai/ha] | 8 DAT¹⁾ | 20.DAT¹⁾ | 8 DAT²⁾ | 20 DAT²⁾ | 8 DAT³⁾ | 20 DAT³⁾ |
| ECHCG | 13 + 13 | 60 | 90 | 36 | 80 | Y | Y |
| ECHCG | 13 + 6.25 | 50 | 85 | 33 | 80 | Y | Y |
| ECHCG | 13 + 1.6 | 50 | 85 | 33 | 80 | Y | Y |
| SETLU | 13 + 1.6 | 70 | 70 | 30 | 69 | Y | Y |
| ALOMY | 100 + 13 | 65 | 80 | 61 | 79 | Y | Y |
| ALOMY | 100 + 6.25 | 55 | 80 | 52 | 75 | Y | Y |
| ALOMY | 13 + 1.6 | 15 | 25 | 0 | 15 | Y | Y |
| SORHA | 50 + 1.6 | 75 | 95 | 72 | 94 | Y | Y |
| SETIT | 100 + 6.25 | 70 | 85 | 62 | 84 | Y | Y |
| SETIT | 50 + 3.1 | 65 | 80 | 48 | 79 | Y | Y |
| CHEAL | 50 + 13 | 80 | 85 | 78 | 77 | Y | Y |
| CHEAL | 50 + 6.25 | 80 | 80 | 74 | 77 | Y | Y |
| CHEAL | 13 + 6.25 | 80 | 70 | 58 | 51 | Y | Y |
| POLCO | 100 + 13 | 98 | 100 | 98 | 99 | Y | Y |
| POLCO | 100 + 1.6 | 80 | 85 | 68 | 69 | Y | Y |
| POLCO | 50 + 1.6 | 75 | 80 | 68 | 65 | Y | Y |
| POLCO | 25 + 1.6 | 75 | 80 | 55 | 65 | Y | Y |
| SOLNI | 100 + 13 | 98 | 100 | 96 | 99 | Y | Y |
| SOLNI | 13 + 13 | 98 | 100 | 96 | 96 | Y | Y |
| XANST | 100 + 6.25 | 90 | 100 | 78 | 91 | Y | Y |
| XANST | 25 + 6.25 | 80 | 100 | 76 | 85 | Y | Y |
| XANST | 13 + 3.1 | 75 | 80 | 70 | 75 | Y | Y |
| XANST | 100 + 1.6 | 65 | 80 | 51 | 75 | Y | Y |
| GALAP | 100 + 13 | 95 | 100 | 94 | 97 | Y | Y |
| GALAP | 25 + 6.25 | 80 | 95 | 74 | 90 | Y | Y |
| GALAP | 100 + 3.1 | 80 | 95 | 78 | 92 | Y | Y |
| GALAP | 25 + 3.1 | 80 | 95 | 70 | 88 | Y | Y |
| GALAP | 100 + 1.6 | 85 | 95 | 75 | 92 | Y | Y |
| GALAP | 25 + 1.6 | 80 | 90 | 66 | 88 | Y | Y |
| KCHSC | 100 + 6.25 | 90 | 90 | 84 | 79 | Y | Y |
| KCHSC | 13 + 6.25 | 90 | 80 | 84 | 65 | Y | Y |

¹⁾observed activity in % destruction 8 or 20 days after treatment
²⁾calculated from the individual activities by Colby's formula
³⁾Synergism: Y = Yes; N = No

TABLE 3
Application in Post-Emergence of pyroxasulfone and compound Ic-1⁴⁾:

| | pyroxasulfone (A) | | Compound B | | pyroxasulfone + Compound Ic-1 | | | |
|---|---|---|---|---|---|---|---|---|
| | use rate | | use rate | | use rate | | | Y/N³⁾ |
| weed | [g ai/ha] | 20 DAT¹⁾ | [g ai/ha] | 20 DAT¹⁾ | [g ai/ha] | 20 DAT¹⁾ | 20 DAT²⁾ | 20 DAT |
| ALOMY | 100 | 80 | 50 | 65 | 100 + 50 | 95 | 93 | Y |
| ALOMY | 50 | 55 | 25 | 45 | 50 + 25 | 95 | 75 | Y |
| AVEFA | 50 | 75 | 25 | 50 | 50 + 25 | 95 | 88 | Y |
| DIGSA | 50 | 80 | 25 | 75 | 50 + 25 | 100 | 95 | Y |
| ECHCG | 50 | 80 | 25 | 65 | 50 + 25 | 98 | 93 | Y |
| LOLMU | 25 | 55 | 12.5 | 75 | 25 + 12.5 | 95 | 89 | Y |
| LOLMU | 12.5 | 55 | 6.25 | 65 | 12.5 + 6.25 | 90 | 84 | Y |
| SETFA | 50 | 85 | 25 | 70 | 50 + 25 | 98 | 96 | Y |
| SETVI | 25 | 75 | 12.5 | 70 | 25 + 12.5 | 95 | 93 | Y |
| CHEAL | 12.5 | 35 | 6.25 | 85 | 12.5 + 6.25 | 100 | 90 | Y |
| MATIN | 25 | 0 | 12.5 | 95 | 25 + 12.5 | 98 | 95 | Y |
| MATIN | 12.5 | 0 | 6.25 | 75 | 12.5 + 6.25 | 90 | 75 | Y |
| POLCO | 12.5 | 35 | 6.25 | 90 | 12.5 + 6.25 | 98 | 94 | Y |

¹⁾observed activity in % destruction 20 days after treatment
²⁾calculated from the individual activities by Colby's formula
³⁾Synergism: Y = Yes; N = No
⁴⁾compound Ic-1: compound of the formula Ic, where R² is chlorine, R⁴ is chlorine, R^{3a} is ethyl, R⁶ is difluoromethoxy and R⁷ is bromine

TABLE 4
Application in Post-Emergence of pyroxasulfone and compound V-1 ⁴⁾:

| | pyroxasulfone (A) | | Compound B | | pyroxasulfone + Compound V-1 | | | |
|---|---|---|---|---|---|---|---|---|
| | use rate | | use rate | | use rate | | | Y/N³⁾ |
| weed | [g ai/ha] | 20 DAT¹⁾ | [g ai/ha] | 20 DAT¹⁾ | [g ai/ha] | 20 DAT¹⁾ | 20 DAT²⁾ | 20 DAT |
| DIGSA | 12.5 | 50 | 3.13 | 35 | 12.5 + 3.125 | 80 | 68 | Y |
| LOLMU | 50 | 55 | 12.5 | 85 | 50 + 12.5 | 98 | 93 | Y |
| SETFA | 50 | 85 | 12.5 | 70 | 50 + 12.5 | 98 | 96 | Y |
| CHEAL | 25 | 45 | 6.25 | 60 | 25 + 6.25 | 95 | 78 | Y |
| GALAP | 12.5 | 40 | 3.13 | 30 | 12.5 + 3.125 | 75 | 58 | Y |
| MATIN | 25 | 0 | 6.25 | 90 | 25 + 6.25 | 95 | 90 | Y |

¹⁾observed activity in % destruction 20 days after treatment
²⁾calculated from the individual activities by Colby's formula
³⁾Synergism: Y = Yes; N = No
⁴⁾compound V-1: compound of the formula V, where R²³ is fluorine, R²⁴ is propargyl, R²⁵ is methyl, R²⁶ is methyl and Y is S.

1. A herbicidal composition comprising:
a) a herbicide A which is 3-[5-(difluoromethoxy)-1-methyl-3-(trifluoromethyl)pyrazol-4-ylmethylsulfonyl]-4,5-dihydro-5,5-dimethyl-1,2-oxazole;
and
b) at least one herbicide B which is selected from protoporphyrinogen-IX-oxidase inhibitors.

2. The composition as claimed in claim 1, wherein the herbicide B comprises at least one compound of the formula I 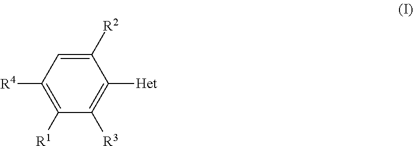
wherein
R¹ is selected from the group consisting of the radicals propargyloxy, allyloxy, isopropyloxy, —C(═O)NHSO₂NR^{1a}R^{1b}, —C(═O)N—NR^{1a}R^{1b}, O—CR^{1a}R^{1c}—C(═O)—OR^{1e}, —C(═O)O—CR^{1a}R^{1c}—C(═O)—OR^{1e}, —C(═O)O—R^{1b}, —C(═O)O—CHR^{1c}-1b, C(═O)NHSO₂NR^{1a}R^{1b}, —NHSO₂NR^{1a}R^{1b}, —SO₂NHC(═O)NR^{1a}R^{1b}, —CH₂—CH(Cl)CO₂—R^{1d} and the radical of the formula OC(CH₃)₂—C(═O)—OR^{1e}; wherein
R^{1a} is hydrogen or C₁-C₄-alkyl;
R^{1b} is C₁-C₄-alkyl;
R^{1c} is hydrogen or C₁-C₄-alkyl;
R^{1d} is hydrogen or C₁-C₄-alkyl or a agriculturally acceptable cation; and
R^{1e} is C₁-C₄-alkyl, propargyl or allyl;
R² is hydrogen, fluorine or chlorine;
R³ is hydrogen or together with R¹ forms a moiety —O—C(R^{3a})═N— or —N═C(R^{3b})—NH—
where R^{3a} and R^{3b} are selected, independently of each other from the group consisting of hydrogen, C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₁-C₆-alkoxy, C₃-C₆-cycloalkyl and C₁-C₂-alkyl substituted by a C₃-C₆-cycloalkyl radical;
R⁴ is halogen or cyano;
and
Het is a heterocyclic radical of formula A or B: 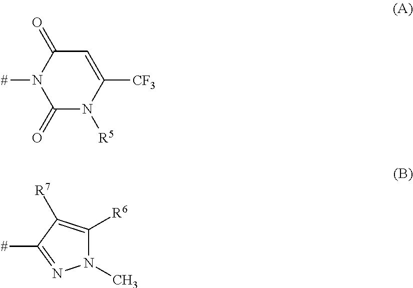
where
R⁵ is selected from the group consisting of hydrogen amino, methyl and propargyl;
R⁶ is selected from the group consisting of difluoromethoxy, trifluoromethyl and methylsulfonyl;
R⁷ is selected from the group consisting of halogen and methyl.

3. The composition as claimed in claim 2, wherein the herbicide B comprises at least one compound of the formula Ia.

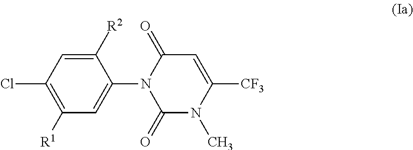

4. The composition as claimed in claim 3, where the compound of the formula Ia is selected from the group consisting of saflufenacil and butafenacil.

5. The composition as claimed in claim 2, wherein the herbicide B comprises at least one compound of the formula Ib.

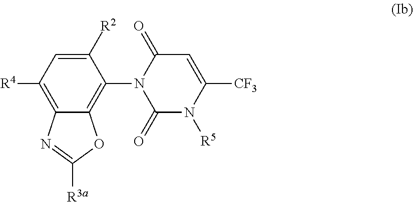

6. The composition as claimed in claim 5, wherein formula Ib R² is fluorine, R⁴ is chlorine, R⁵ is methyl and R^{3a} is cyclopropylmethyl.

7. The composition as claimed in claim 2, wherein the herbicide B comprises at least one compound of the formula Ic.

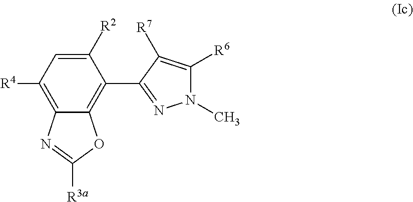

8. The composition as claimed in claim 7, where in formula Ic R² is fluorine or chlorine, R⁴ is chlorine, R^{3a} is ethyl, R⁶ is difluoromethoxy and R⁷ is chlorine or bromine.

9. The composition as claimed in claim 2, wherein the herbicide B comprises at least one compound of the formula Id.

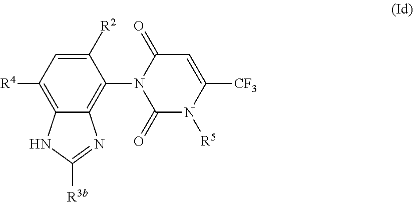

10. The composition as claimed in claim 9, where in formula Id R² is fluorine, R⁴ is chlorine, R⁵ is methyl and R^{3b} is trifluoromethyl.

11. The composition as claimed in claim 1, wherein the herbicide B comprises at least one compound of the formula II 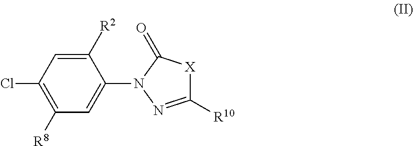
wherein
X is O or NR¹¹,
R⁸ is selected from the group consisting of propargyloxy, allyloxy, isopropyloxy, the radical of the formula CH₂—CH(Cl)CO₂—R¹² and the radical of the formula NH—SO₂—CH₃;
R⁹ is fluorine or chlorine;
R¹⁰ is CH₃ or tertbutyl;
R¹¹ is CHF₂, or together with R¹⁰ may form 1,4-butandiyl;
R¹² is hydrogen, C₁-C₆-alkyl or and agriculturally acceptable cation.

12. The composition as claimed in claim 11, where the compound of the formula II is selected from the group consisting of carfentrazone, or its salts and/or its esters, sulfentrazone, azafenidine, oxadiargyl and oxadiazon.

13. The composition as claimed in claim 1, wherein the herbicide B comprises at least one compound of the formula III 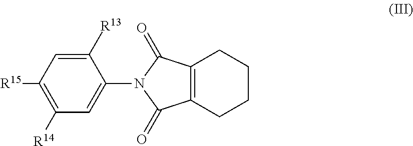
wherein
R¹³ is hydrogen, fluorine or chlorine;
R¹⁴ is selected from the group consisting of propargyloxy, allyloxy, 1-methyl-2-propinyloxy, O—CH₂CO₂—R¹⁶, CH═C(Cl)CO₂—R¹⁶ and isopropyloxy;
R¹⁵ is fluorine or chlorine; or
R¹⁴ and R¹⁵ together form a moiety —O—CH₂—C(═O)—NR¹⁷—, where R¹⁷ is a propargyl radical and where the oxygen atom is meta with regard to the position of R¹³;
R¹⁶ is hydrogen, C₁-C₆-alkyl or an agriculturally acceptable cation.

14. The composition as claimed in claim 13, where the compound of the formula III is selected from the group consisting of cinidon, or its salts and/or its esters, flumiclorac, or its salts and/or its esters, flumioxazin and flumipropyn.

15. The composition as claimed in claim 1, wherein the herbicide compound B comprises at least one compound of the formula IV 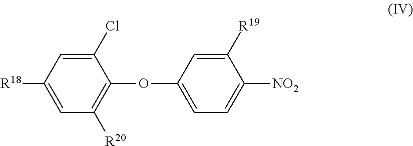
wherein
R¹⁸ is chlorine or trifluoromethyl;
R¹⁹ is selected from the group consisting of hydrogen, C₁-C₄-alkoxy, —CO₂—R²¹, —C(═O)O—CH₂CO₂—R²¹, —C(═O)O—CH(CH₃)CO₂—R²¹, and —C(═O)NH—SO₂—R²²;
R²⁰ is hydrogen, fluorine or chlorine;
R²¹ is hydrogen, C₁-C₆-alkyl or a agriculturally acceptable cation; and
R²² is C₁-C₄-alkyl.

16. The composition as claimed in claim 15, where the compound of the formula IV is selected from the group consisting of nitrofen, bifenox, oxyfluorfen, acifluorfen, or its salts and/or its esters, fomesafen, lactofen, halosafen, chlornitrofen, fluornitrofen, chlomethoxyfen and nitrofluorfen.

17. The composition as claimed in claim 16, where the compound of the formula IV is oxyfluorfen.

18. The composition as claimed in claim 1, wherein the herbicide B comprises at least one compound of the formula V 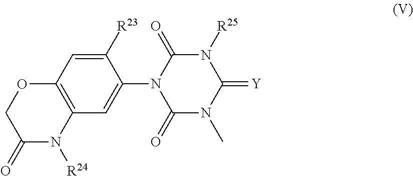
wherein
R²³ is hydrogen, fluorine or chlorine;
R²⁴ is selected from the group consisting of hydrogen, C₁-C₆-alkyl, C₁-C₆-haloalkyl, C₃-C₆-alkenyl, C₃-C₆-haloalkenyl, C₃-C₆-alkynyl, C₃-C₆-haloalkynyl, C₁-C₆-alkoxy, C₃-C₆-cycloalkyl and C₁-C₂-alkyl substituted by a C₃-C₆-cycloalkyl radical;
R²⁵ is selected from the group consisting of hydrogen, amino, methyl and propargyl;
R²⁶ is selected from the group consisting of hydrogen and methyl; and Y is O or S.

19. The composition as claimed in claim 18, where in formula V R²³ is fluorine, R²⁴ is propargyl, R²⁵ is methyl, R²⁶ is methyl and Y is S.

20. The composition as claimed in claim 1, wherein the herbicide B comprises at least one compound of the formula VI 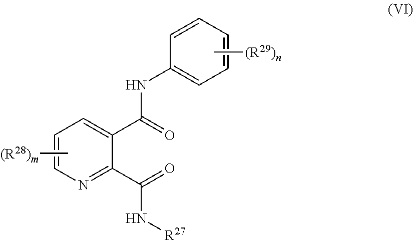
wherein
m is 0, 1, 2, or 3;
n is 0, 1, 2, 3 or 4;
R²⁷ is selected from the group consisting of C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₃-C₆-cycloalkyl, C₁-C₄-alkyl substituted by a C₁-C₄-alkoxy radical, and C₁-C₂-alkyl substituted by a C₃-C₆-cycloalkyl radical;
R²⁸ is selected from the group consisting of halogen, C₁-C₃-alkyl, C₁-C₃-haloalkyl, C₁-C₃-alkoxy, and C₁-C₃-alkyl substituted by a C₁-C₃-alkoxy radical, it being possible for m=2 or 3 that the radicals R²⁸ are identical or different from each other;
R²⁹ is selected from the group consisting of halogen, cyano, nitro, C₁-C₄-alkyl, C₁-C₄-haloalkyl, C₁-C₄-alkylsulfonyl, C₁-C₄-alkoxy, C₁-C₄-alkyl substituted by a C₁-C₄-alkoxy radical, C₁-C₂-alkyl substituted by a C₃-C₆-cycloalkyl radical, and a radical CO₂R³⁰, it being possible for n=2, 3 or 4 that the radicals R²⁹ are identical or different from each other;
R³⁰ is selected from the group consisting of C₁-C₆-alkyl, C₁-C₆-haloalkyl, C₃-C₆-alkenyl, C₃-C₆-haloalkenyl, C₃-C₆-alkylnyl, C₃-C₆-haloalkylnyl, C₃-C₆-cycloalkyl, C₁-C₄-alkyl substituted by a C₁-C₄-alkoxy radical, and C₁-C₂-alkyl substituted by a C₃-C₆-cycloalkyl radical.

21. The composition as claimed in claim 20, wherein the herbicide B comprises at least one compound of the formula VIa

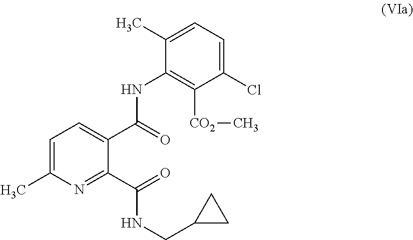

22. The composition as claimed in claim 1, containing no safener.

23. The composition as claimed in claim 1, wherein the relative amount of herbicide A to the at least one herbicide B is from 100:1 to 1:100.

24. (canceled)

25. (canceled)

26. (canceled)

27. (canceled)

28. A method for controlling undesirable vegetation, which comprises allowing the composition as claimed in claim 1 to act on plants to be controlled or their habitat.

29. The method for controlling undesired vegetation as claimed in claim 28, which comprises applying the composition before, during and/or after the emergence of the undesirable vegitation; the herbicides A and B being applied simultaneously or in succession.

30. An herbicide formulation comprising the composition as claimed in claim 1 and at least one solid or liquid carrier.

31. The method as claimed in claim 29, wherein undesirable vegetation in crop plants are controlled.

32. The method as claimed in claim 31, wherein the crop plants are crops of wheat, barley, rye, triticale, durum, rice, corn, sugarcane, sorghum, soybean, pulse crops, peanut, sunflower, sugarbeet, potato, cotton, brassica crops, turf, grapes, pomefruit, stonefruit, citrus, coffee, pistachio, garden ornamentals, bulb ornamentals, onion, garlic, conifers or deciduous trees.

33. The method as claimed in claim 31, where the crop plants are resistant to herbicides acting as protoporphyrinogen-IX-oxidase inhibitors.
